(19) United States
(12) Patent Application Publication
(10) Pub. No.: US 2009/0095686 A1
(43) Pub. Date: Apr. 16, 2009

(54) Process And System For Treating Waste From Aluminum Production Containing PAH And Fluoride Ions By Flotation And Stabilization

(76) Inventors: Myriam Chartier, Quebec (CA); Aurelie Dhenain, Quebec (CA); Guy Mercier, Quebec (CA); Jean-Francois Blais, Beauport (CA); Patrick Drogui, Beauport (CA); Ghislain Bongo, Sainte-Foy (CA)

Correspondence Address: JACOBSON HOLMAN PLLC, 400 SEVENTH STREET N.W., SUITE 600, WASHINGTON, DC, 20004, US

(21) Appl. No.: 12/119,433

(22) Filed: May 12, 2008

(30) Foreign Application Priority Data
May 11, 2007 (CA) CA 2,588,929

(51) Int. Cl. B03D 1/02; B03D 1/14

(52) U.S. Cl. 210/696; 210/150; 210/151

(57) ABSTRACT

A process for treating a waste material coming from aluminum production, the waste material containing contaminants polycyclic aromatic hydrocarbons (PAH) and inorganic fluoride compounds containing fluoride ions, involves flotation of a waste mixture of the waste material in the presence of a surfactant capable of producing PAH-rich micelles that are floated to produce froth containing the PAH-rich micelles; and stabilization of the waste mixture by adding a fluoride ion stabilizer to form stabilized fluoride compounds with reduced solubility in the waste mixture and in a toxicity characteristics leaching procedure test, to produce decontaminated solids containing the stabilized fluoride compounds and a leachate solution.

### FIELD OF THE INVENTION

The present invention concerns the treatment of waste material from aluminum production and more particularly to a process and system for treating such waste material to remove polycyclic aromatic hydrocarbons (PAH) and inorganic leachable fluoride ions.

### BACKGROUND

Transforming alumina into aluminum is a particularly polluting process since it generates waste that may be considered as dangerous material. Waste material coming from aluminum production is made of solids of different size and form that include equipment used in the primary fusion step, residues of equipment cleaning materials, crusts of the electrolysis cells, soiled source material and/or pieces of finished material susceptible of being contaminated by toxic substances such as polycyclic aromatic hydrocarbons (PAH) and compounds containing leachable fluoride ions.

Table 1 presents a characterization and description of waste material coming from aluminum production.

TABLE 1

| Materials | Description |
|---|---|
| Melting pot waste | Refractory bricks |
| Contact bars | Metal for current conduction |
| Glaze or liner pieces | Compounds of brick and graphite making the |
| | cathode |
| Carbon blocks | Used for making cathode |
| Contaminated alumina | Primary material |
| Cell waste | Pieces of crust lining the cell |
| Paste waste | Composed of pitch and coke |
| Filtration bags | Used for air filtration |
| Pitch | Material for making anodes |
| Waste from cleaning | Black or brown dust like particles obtained |
| ventilation conduits | during cleaning of the ventilation system |
| Floor sweepings | Black or brown dust like particles obtained |
| | from cleaning the plant |
| Waste from cleaning | |
| purifiers | |
| Sheet metal | Divers metal pieces coming from the plant |
| Oil absorbents | Used for absorbing oils and greases or other |
| | compounds |
| Air filters | Required for air filtration |
| Others | Clothing, tissues, gloves, newspapers, etc. |

Table 2 presents various chemical compounds including some potentially dangerous substances present in the waste material coming from aluminum production.

TABLE 2

| Contaminants | Compounds |
|---|---|
| Fluorides | Cryolite |
| | Calcium fluoride |
| | Sodium fluoride |
| | Aluminum fluoride |
| | Pachnolite |
| | Others |
| PAH | 16 different PAH compounds |
| Cyanides | NaCN, HCN |
| Oils and greases | Variable |

### PAH Compounds and Leachable Fluoride Ions

The contamination of waste by PAH compounds is a result of transformation processes that use Söderberge-type anodes or pre-cured anodes. PAH compounds are products that are present in the pitch and the coke used in the manufacture of anodes for the electrolytic cell for the electrolytic reduction of alumina into aluminum. Generally associated with fine particles, PAH compounds are principally located in the sub-products resulting from the cleaning of the air purification and ventilation systems used at the aluminum smelters or plants.

Many PAH compounds are classified as hazardous and/or carcinogenic, for instance benzo(a)pyrene is considered carcinogenic, while dibenzo(a,h)anthracene and benzo(b,j,k)fluoranthene and indeno(c,d)pyrene are considered to be probably or possibly carcinogenic.

This waste material is also contaminated with a variety of fluoride compounds. During aluminum production, numerous fluoride-based compounds are used, such as CaF₂ and LiF, which generates smelter waste contaminated with fluoride compounds. This waste is considered a dangerous material because the leachate from a toxicity characteristics leaching procedure (TCLP) test contains a quantity of fluorides above the norm of 150 mg F−/L, which has been established, for instance, by the Ministère du développement durable de l'environnement et des pares du Québec. This TCLP test allows a simulation of the risks of toxic compounds' leaching into the environment. The exposure of fluoride compounds to humans or other organisms can cause noxious effects on their health and the environment at large.

Disposal of Waste Material from Aluminum Production

The classic manner of eliminating aluminum production waste has been via subsurface containment, i.e. by burying or enterring the waste in a secure manner. However, the saturation of such subsurface containment sites, the rising price of enterring and of greenhouse gas emissions inherent in the transportation of the waste to the containment site, have made this method of dealing with waste from aluminum production disadvantageous.

At this juncture in time, the use of physio-chemical processes to treat aluminum production waste remains substantially unexplored.

### Processes for Treating Fluorides

Some studies have been done pertaining to the extraction of fluoride ions by acidic or basic leaching processes on soils (Arnesen, A. K. M. (1997). “Availability of fluoride to plants grown in contamined soils”. Plant Soil, 191, 13-25; and Arnesen, A. K. M., and Krogstad, T. (1998). “Sorption and desorption of fluoride in soil polluted from the aluminum smelter at Årdal in western Norway”. Water Air Soil Pollut., 103, 357-373) as well as on solid waste (Bontron, J. C., Personnet, P. B., and Lamerant, J. M. (1993). “Process for wet treatment of spent pot linings from Hall-Heroult electrolytics cells”. U.S. Pat. No. 5,245,116; Kasireddy, V. K, Bernier, J. L., and Kimmerle, F. M. (2002). “Recycling spent pot linings”. U.S. patent application, No. 20020114748; Moufti, A, and Mountadar, M. (2004). “Lessivage des fluorures et des métaux à partir d'une cendre à charbon”. Water Qual. Res. J. Can., 39(2), 113-118 (in French); Pawlek, R. P. (1993). “Spent potlining: water soluble components, landfill and alternatives solutions”. S. K. Das S. K., ed., Lights Metals. 1993 TMS Annual Meeting in Denver, Colo., Feb. 21-25, 1993. The Minerals, Metals & Materials Society, Warrendale, Pa., pp. 399-405; Piekos, R., and Paslawska, S. (1998). “Leaching characteristics of fluoride from coal fly ash”. Fluoride, 31(4), 188-192; Pong, T. K., Adrien, R. J., Besida, J., O'Donnell, T. A., and Wood, D. G. (2000). “Spent potlining—a hazardous waste made safe”. Process Safety Environ. Protection, 78(3), 204-208; and Pulvirenti, A. L., Mastropietro, C. W., Barkatt, A., and Finger, S. M. (1996). “Chemical treatment of spent carbon liners used in the electrolytic production of aluminum”. J. Hazard. Mater., 46, 13-21).

U.S. Pat. No. 5,558,847 (KAABER et al.) discloses a process for recuperating fluoride ions and aluminum from solid waste that may notably be emitted from the aluminum production industry. The process includes leaching the waste in an acidic medium with a pH varying between 0 and 3.0 using sulphuric acid at a temperature of 50 to 90° C. for 60 min. The process also includes a step of cooling the suspension to between 40 and 60° C., followed by adjusting the pH to between 3.7 and 4.1 using a diluted solution of NaOH. This neutralized solution is then filtered and the resulting liquid fraction is then heated to 90 to 95° C. This promotes the co-precipitation of fluoride and aluminum ions in the form of hydrated salts AlF₂OH.xH₂O.

U.S. Pat. No. 4,900,535 (GOODES et al.) discloses a process for decontaminating waste material such as spent cathode liners and recuperating the fluoride ions. The ash may be beneficiated by adding a lime slurry and it is then sent to a sulpholysis reactor which requires high temperatures.

### Processes for Treating PAH

In the case of PAH compounds, known treatment methods are divided into two categories: elimination or degradation methods and removal methods.

Elimination or degradation methods include biological treatments using microbial degradation or bioremediation. These methods also include physical treatments that are more efficient but costly and of which the principal examples are incineration, thermal desorption, physiochemical treating with UV and ultrasound, and δ radiation. Other methods involve chemical treating by reactions using oxidizing agents such as ozone and hydrogen peroxide.

The PAH removal methods involve chemical extraction performed by leaching or by flotation facilitated by surfactants (Cheah, E. P. S., Reible, D. D., Valsaraj, K. T., Constant, D. W., Walsh, B. W., and Thibodeaux, L. J. (1998). “Simulation of soil washing with surfactants”. J. Hazard. Mater., 59, 107-122; Cheng, K. Y., and Wong, J. W. C. (2006). “Combined effect of nonionic surfactant Tween 80 and DOM on the behaviors of HAP in soil-water system”. Chemosphere, 62, 1907-1916; Dhenain, A., Mercier, G., Blais, J. F., and Bergeron, M. (2006). “HAP removal from black sludge from aluminum industry by flotation using non ionic surfactants”. Environ. Technol., 26, 1019-1030; Edwards, D. A., Luthy, R. G., and Lui, Z. (1991). “Solubilization of polycyclic aromatic hydrocarbons in micellar non ionic surfactant solutions”. Environ. Sci. Technol., 25, 127-133; Gabet, S. (2004). “Remobilisation d'hydrocarbures aromatiques polycycliques (HAP) présents dans les sols contaminés à l'aide d'un tensioactif d'origine biologique”. Ph.D. thesis, Université de Limoges, Limoges, France (in French); Lopez, J., Iturbe, R., and Torres, L. G. (2004). “Washing of soil contaminated with HAPs and heavy petroleum fractions using two anionic and one ionic surfactant: effect of salt addition”. J. Environ. Sci. Health, A39(9), 2293-2306; Zhou, W., and Zhu, L. (2006). “Efficiency of surfactant-enhanced desorption for contaminated soils depending on the component characteristics of soil-surfactant-HAPs system”. Environ. Pollut., 147(1), 66-73; Zhu, L., and Feng, S. (2003). “Synergistic solubilization of polycyclic aromatic hydrocarbons by mixed anionic-nonionic surfactants”. Chemosphere, 53, 459-467; and Zhu, L., Chen, B., and Tao, S. (2004). “Sorption behavior of polycyclic aromatic hydrocarbons in soil systems containing nonionic surfactants”. Environ. Eng. Sci., 21, 263-272).

The role of the surfactant in the leaching treatment of the matrix material polluted with PAH is, summarily, to mobilize and then trap the hydrophobic contaminants.

Table 3 shows some types of surfactants that have been used to remove PAH compounds.

TABLE 3

| Surfactant | Chemical name | Type |
|---|---|---|
| Brij 35 ™ | Alcohol lauryl | non ionic |
| | ethoxylate | |
| Emulgin 600 ™ | Nonyl phenol ethoxylate | non ionic |
| EO/PO ™ | Polymer ethylene oxyde/propyleneoxyde | non ionic |
| Igepal CA-720 ™ | Octylphenol | non ionic |
| | polyoxyethylene | |
| SDS ™ | Sodium dodecyl sulphate | anionic |
| Tergitol NP-10 ™ | Nonylphenol polyoxyethylene | non ionic |
| Triton X 100 ™ | Octyl phenol ethoxylate | non ionic |
| Tween 20 ™ | Polyoxyethylene (20) sorbitan | non ionic |
| | monolaurate | |
| Tween 80 ™ | Polyoxyethylene (80) sorbitan | non ionic |
| | monolaurate | |

U.S. Pat. No. 7,056,061 (KUKOR et al.) discloses a process for decontaminating industrial waste polluted by PAH compounds, combining biological and chemical treatment. The waste is first treated biologically and subsequently with a chemical oxidation step involving treatment with a transition metal such as ferric or ferrous iron in soluble form, a chelator of the transition metal to form a metal-chelator complex, and an oxidizing agent such as hydrogen peroxide to form OH free radicals.

U.S. Pat. No. 5,425,881 (SZEJTLI et al.) discloses a process for extracting PAH from decontaminated soils. The process treats the solid matrix in one step by adding 10 to 20% of an organic biodegradable solvent, such as cyclodextrin, promoting the desorption of the PAH compounds. At the same time, bacterial microflora or fungi is inoculated in the suspension in the presence of nutrients to support the bacterial activity to degrade the PAH.

The above-mentioned decontamination processes mostly have been conceived to specifically treat waste contaminated either with fluoride ions or with PAH. These processes are inappropriate for meeting the environmental standards in the case of waste material polluted with both inorganic fluoride pollutants and organic PAH pollutants, as is the case for waste from aluminum production. In addition, the processes developed by KAABER et al. and GOODES et al. for recuperating fluoride ions requires external heating sometimes to temperatures up to 800° C. This heating requirement implies various drawbacks and complications in such a decontamination system and can lead to excessive energy consumption in industrial operation. Furthermore, the PAH degradation processes combining biological and chemical treatment as in KUKOR et al. and SZEJTLI et al. may encounter difficulties and inefficiencies in developing and maintaining efficient micro-organisms acclimatized to the waste media and operating conditions.

Indeed, what is known in the field for treating aluminum production waste has a variety of disadvantages when it comes to treating waste containing both PAH compounds and inorganic leachable fluoride ions.

There is presently a need for a technology that overcomes at least some of the disadvantages of what is known in the field.

### SUMMARY OF THE INVENTION

The present invention responds to above-mentioned need by providing a process and a system for treating waste coming from aluminum production containing contaminants comprising polycyclic aromatic hydrocarbons (PAH) and inorganic fluoride compounds containing leachable fluoride ions.

According to an embodiment of the present invention, there is a process comprising in no particular order flotation of a waste mixture comprising the waste material in the presence of a surfactant capable of producing PAH-rich micelles that are floated to produce froth comprising the PAH-rich micelles; and stabilization of the waste mixture by adding a fluoride ion stabilizer to form stabilized fluoride compounds with reduced solubility in the waste mixture and in a toxicity characteristics leaching procedure test, to thereby produce decontaminated solids comprising the stabilized fluoride compounds and a leachate solution.

In one embodiment of the process, it includes:
a) mixing the waste material with a first liquid to produce the waste mixture;
b) adding the surfactant to the waste mixture;
c) generating vapor bubbles in the waste mixture to produce the froth comprising the PAH-rich micelles via flotation, as well as a PAH-poor solution and residual solid waste; and
d) mixing the residual solid waste with a second liquid and the fluoride ion stabilizer to form the stabilized fluoride compounds with reduced solubility in the second liquid and in a toxicity characteristics leaching procedure test, to thereby produce the decontaminated solids comprising the stabilized fluoride compounds and the leachate solution.

The present invention also provides a system for treating waste material waste coming from aluminum production.

In one embodiment, the system includes a flotation vessel for receiving a first liquid and the waste material to produce a waste mixture therein; a surfactant inlet in fluid communication with the flotation vessel for providing a surfactant into the flotation vessel capable of producing PAH-rich micelles in the waste mixture; and a vapor bubble generator connected to the flotation vessel for generating vapor bubbles in the waste mixture, to produce PAH-rich froth, a PAH-poor solution and residual solid waste. The system also includes a stabilization vessel for receiving a second liquid and the waste mixture or the residual solid waste; and a stabilizer inlet in fluid communication with the stabilization vessel for providing a fluoride ion stabilizer therein to mix with the second liquid and the waste mixture or the residual solid waste, to form stabilized fluoride compounds with reduced solubility in the second liquid and in a toxicity characteristics leaching procedure test, to thereby produce decontaminated solids and a leachate solution.

### BRIEF DESCRIPTION OF THE DRAWINGS

FIG. 1 is a block diagram of an embodiment of the process according to the present invention.

FIG. 2 is an X-ray diffraction graph for the E_{C}04 waste material sample showing the predominant mineral phases.

FIG. 3 is an X-ray diffraction graph of the solid residue after decantation.

FIG. 4 is a graph of the distribution as a function of pH of aluminum species in the leachate obtained by MINEQL+(version 4.5) simulation at simulation conditions: [Al]_{T}=1.02×10⁻² M, [F]_{T}=4.84×10⁻³ M, [Ca]_{T}=5.99×10⁻⁵ M, [Na]_{T}=2.75×10⁻² M, [SO₄]_{T}=2.70×10⁻³ M (pH=7) et [SO₄]_{T}=2.53×10⁻³ M (pH=12), T=25° C., closed system, and solids not included.

FIG. 5 is a graph of the Distribution as a function of pH of fluoride species in the leachate obtained by MINEQL+(version 4.5) simulation at simulation conditions: [Al]_{T}=1.02×10⁻² M, [F]_{T}=4.84×10⁻³ M, [Ca]_{T}=5.99×10⁻⁵ M, [Na]_{T}=2.75×10⁻² M, [SO₄]_{T}=2.70×10⁻³ M (pH=7) et [SO₄]_{T}=2.53×10⁻³ M (pH=12), T=25° C., closed system, and solids not included.

FIG. 6 is a hybrid block diagram and side cut view of a flotation cell of one embodiment of the process of the present invention.

FIG. 7 is a block diagram of an embodiment of the process according to the present invention, where the fractions are labeled and quantities of additions are indicated.

FIG. 8 is a graph of benzo(b,j,k)fluoranthene (BJK) and chrysene removal in the decontaminated solids (DAW) for each of the loops B1 to B6.

FIG. 9 is a graph of froth concentrate (FCO) production and PAH concentration for each of the loops B1 to B6.

FIG. 10 is a graph of fluoride concentrations in solution in the untreated waste material (NAW) and in the decontaminated solids (DAW) for each of the loops B1 to B6, according to TCLP tests.

### DETAILED DESCRIPTION OF THE PREFERRED EMBODIMENTS

Preferred embodiments of the process and the system of the present invention will now be described with reference to the Figures.

The process and system of the present invention enable the co-removal of two different contaminants, PAH and leachable fluoride ions, using flotation in the presence of a surfactant and stabilization.

### DEFINITIONS

“Waste material coming from aluminum production” means waste that comes from the production of aluminum from alumina, and may include but is not limited to electrolytic cell liners, crusts or cleaning washout; electrolytic reaction by-products; compounds escaping from the electrolytic cell that have condensed; dust, sub-products or other materials recuperated from air purification and ventilation systems used at a smelter; and other materials polluted with leachable fluoride ion compounds and PAH resulting from aluminum production. Table 1 presents a summary of possible waste materials.

“PAH” means polycyclic aromatic hydrocarbons and includes a variety of organic compounds that have at least two fused aromatic rings. A non exhaustive list of PAH compounds includes naphthalene, acenaphthylene, acenaphthene, fluorine, phenantrene, anthracène, fluoranthene, pyrene, benzo(a)anthracene, chrysene, benzo(b)fluoranthene, Benzo(k)fluoranthene, benzo(a)pyrene, indeno(1,2,3-cd)pyrene, benzo(g,h,i)perylene, and dibenzo(a,h)anthracene.

“Surfactant” means a compound that lowers the surface tension of a liquid, has hydrophobic and hydrophilic portions and is capable of forming micelles that are rich in PAH. The surfactants according to the present invention do not include the one of formula I:

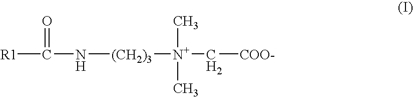

wherein R1 is C₁₂H₂₅ and wherein it is used at conditions of 0.5% p/p of BW and 10% total solids in the waste mixture.

“Intermolecular distance between hydrophilic charged groups” with reference to zwitterions surfactants, means the distance following the intermittent atoms joining the two groups and not, for instance, the distance between the groups when that portion of the molecule has curled on itself so the groups are near to each other.

“Froth” means the floated material resulting from the flotation. The froth includes vapor bubbles and PAH-rich micelles. The froth may also include other compounds that were floated by the bubbles due to an affinity with the vapor bubbles and entrapment by the micelles. The froth usually would be located on the top surface of the liquid phase, especially when a batch reactor vessel is used, and is often in the form of a foam-like substance.

“Vapor bubbles” means bubbles of a gas that are generated in solution during the flotation step. The vapor bubbles have a size and properties enabling the flotation of the PAH-rich micelles to form the PAH-rich froth. The flotation may be performed in a variety of ways depending on reactor design and operating conditions. The vapor is preferably air but may also be another gas or gas mixture enabling flotation of the micelles.

“Fluoride ion stabilizer” stands for a substance useful in extracting fluoride ions from the waste mixture. The stabilizer forms stabilized compounds with at least some of the fluoride ions to bring them out of solution. Thus, the stabilized compounds have a reduced solubility in the liquid, at the given operating conditions, to enable precipitation. In addition, the fluoride ion stabilizer should form stabilized compounds that have a low degree of solubility and toxicity, so as to not unduly contaminate the environment. The degree of acceptable toxicity of the stabilized compounds will depend on regulatory standards, such as the TCLP standard, but these may vary from territory to territory. In general, the stabilized compounds are less soluble and less harmful than the pre-treated fluoride compounds.

### Embodiments and Aspects of the Process

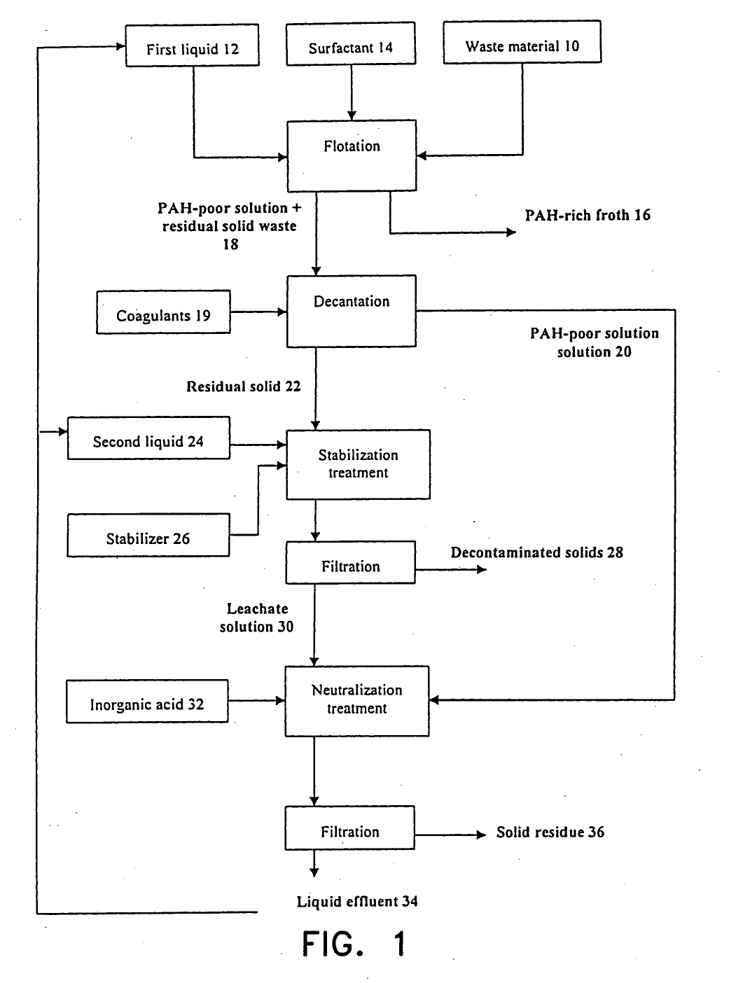

Referring to FIG. 1, showing a block diagram of one embodiment of the process, the material to be treated is waste material 10 coming from aluminum production.

The illustrated embodiment of the process includes a) mixing the waste material 10 with a first liquid 12 to produce a waste mixture. The first liquid may be an aqueous solution, which may be water or a recirculation stream from a downstream unit of the process, which will be further discussed hereinbelow.

Optionally, there may be a step of reducing the size of the waste material particle size, or separating out bulky pieces or particles prior to the flotation or stabilization steps. The content of fluoride ions depends on the particle size of the waste material. In one optional aspect on the process, waste material having a particle size under 50 mm is crushed and treated. In another optional aspect of the process, waste material having a particle size above 2 mm undergoes grinding, crushing or another size reduction treatment, to produce a particle size of about 1 mm.

The waste material may be present in an amount between about 5 and about 20 wt % relative to the total weight of the waste mixture, and preferably in an amount of about 15 wt % relative to the total weight of the waste mixture.

The process also includes b) adding a surfactant 14 to the waste mixture capable of producing PAH-rich micelles. It should be noted that the surfactant may be added before, during or after the waste mixture is made. In one optional aspect of the process, the surfactant is added to the mixture and agitation is performed to mix it.

Regarding the surfactant 14, it may be a charged or non-charged species. Optionally, the surfactant may be a variety of zwitterions or non-ionic compounds, but excludes the compounds of formula I mentioned hereinabove at the particular conditions.

When the surfactant is a zwitterions, it preferably has two hydrophilic charged groups, such as N+ and SO3−, which are spaced apart at an intermolecular distance of more than about 5 Å. In one optional aspect of the surfactant, the intermolecular distance is between about 6 Å and about 7 Å. The zwitterion surfactant may be a sulfobetaine. It may also be a hydroxysultaine.

In one optional aspect of the process, the surfactant is cocamidopropyl hydroxysultaine (hereinafter referred to as CAS). It has been found that CAS offers an improved mobilisation rate of various PAH compounds including benzo(b,j,k)fluoranthene (hereinafter BJK), benzo(a)pyrene and chrysene. For instance, the washing and flotation with CAS enabled a 35% removal of BJK compared with 25% and 10% obtained using Triton X-100 and Tween 80 respectively; and also enabled a 37% removal of chrysene compared with 24% and 3% obtained using Triton X-100 and Tween 80 respectively. By its structure and interaction within the complex system of the waste mixture, the CAS surfactant presents improved entrapment of PAH compounds and flotation removal of such contaminants.

According to an embodiment of the invention, the surfactant may be added in a percentage of about 0.2 to about 2% by weight relative to the dry basis weight of the waste material. In one optional aspect of the process, such as when the surfactant is CAS, it is added in an amount of about 0.25% by weight relative to the dry basis weight of the waste material. At this concentration, the CAS surfactant enabled flotation removal of PAH compounds while minimizing production of dangerous reject. Of course, it should be understood that different surfactants may be added in different amounts, depending on their structure and the critical micelle concentration (CMC) of the surfactant in the solution. The amount of surfactant will depend on the nature of the same and the waste material but will be apparent to a person skilled in the art.

In another optional aspect of the surfactant, it may be a non-ionic surfactant. The non-ionic surfactant may be one of the surfactants defined as formula II or formula III, or a combination thereof:

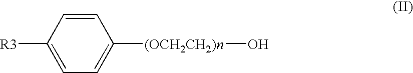

wherein R3 is about C8H17 and n is about 10; and

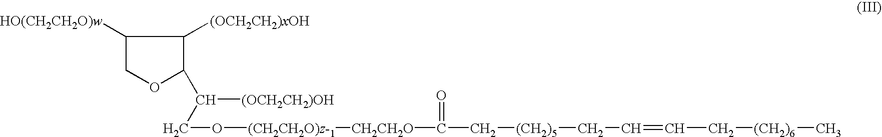

wherein the sum of w+x+y+z is about 20.

Non-ionic surfactants such as Tween 80™ or Triton X100™ were shown to remove various types of PAH compounds in the flotation step, which is further described hereinbelow.

The process further includes c) generating vapor bubbles in the waste mixture to produce froth 16 that includes the PAH-rich micelles. This step may also be referred to as “flotation” and also produces a PAH-poor solution and residual solid waste (shown as combined stream 18 in FIG. 1). The vapor bubbles are preferably air bubbles, which may be generated by an agitator or by air injection.

The flotation step presents increased efficiency for removing the PAH-rich micelles, for instance as compared to centrifugation or filtration, as per the examples hereinbelow.

In another optional aspect of the process, the PAH-poor solution and residual solid waste 18 are separated, for instance by decantation. To aid in the decantation, coagulants 19 (also referred to herein as “precipitation agents”) may be optionally added. The coagulants 19 may be but are not limited to FeCl₃, Percol 765 or another such coagulant, or a combination thereof. Once the decantation is complete, the PAH-poor solution 20 is separated from the residual solid waste 22. The PAH-poor solution 20 may be sent for further processing as will be described hereinbelow in relation to the neutralization step.

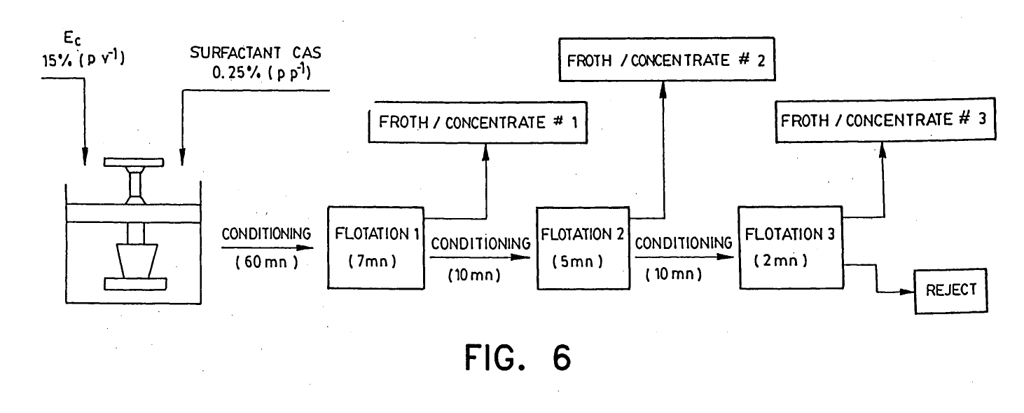

In another aspect of the process, the flotation step and the subsequent removal of the PAH-rich froth are performed sequentially multiple times on the waste mixture before performing downstream steps. For instance, as shown in FIG. 6, the flotation and froth removal may be done three times at the conditions of the examples and embodiments further described herein, before sending the residual solid waste for stabilization treatment.

The process also includes d) a stabilization treatment that includes mixing the residual solid waste 22, preferably once it has been separated from the PAH-poor solution 20 as described above, with a second liquid 24 and a fluoride ion stabilizer 26. This second liquid is preferably aqueous. The fluoride ion stabilizer is added in order to form stabilized fluoride compounds with reduced solubility in the second liquid 24, to thereby produce decontaminated solids 28 comprising the stabilized fluoride compounds and a leachate solution 30. This step may also be referred to as the “stabilization” step.

Regarding the fluoride ion stabilizer 26, it may be a variety of compounds or compositions that allow the fluoride ions to be precipitated out of solution in a stable form. The fluoride ion stabilizer may be one or more compounds that allow an increase in pH and that also contain a phosphate and/or an alkali metal. The phosphate and/or the alkali metal can then form the stabilized fluoride compounds. In one optional embodiment of the fluoride ion stabilizer, it is Ca(OH)₂, which both raises the pH and has the an alkali metal Ca²⁺ that combines with the fluoride ions to form the stabilized fluoride compound CaF₂. In another optional embodiment, the fluoride ion stabilizer includes a phosphate that forms fluoroapatite (also known as calcium halophosphate or Ca₅(PO₄)₃F). Alternatively, it may be that other stabilizers can be used such as a base in combination with an alkali hydroxide, a base in combination with CaCl₂ or another calcium compound that under the basic conditions will liberate Ca²⁺ to form CaF₂.

In addition, the stabilizer may include a combination of different calcium and phosphate compounds, along with a base if needed.

The stabilizer 26 may be added in an amount and composition to raise the pH to between about 9 and about 12, and preferably to about 11. When Ca(OH)₂ is used as the stabilizer, it may be added in an amount between about 10 and about 12 g per L of the total volume of the liquid 24 and residual solid 22.

In an optional aspect of the process, after the stabilization treatment, the decontaminated solids 28 are separated from the leachate solution 30. This may be done by vacuum filtration or another means of solid-liquid separation. The decontaminated solids 28 notably contain leachable fluorides below 150 mg F−/L when performing TCLP test on it.

In another optional aspect of the process, the leachate solution 30 is further processed to recover fluoride ions that are still present. According to the illustrated embodiment, there may be a step e) of neutralizing the leachate solution 30 as well as the PAH-poor solution 20 by adding thereto an inorganic acid 32 to induce precipitation of the fluoride ions remaining in solution, to thereby produce a liquid effluent 34 and a solid residue 36, which may be separated by vacuum filtration for example. The inorganic acid 32 of step e) is optionally H₂SO₄. Also optionally, the PAH-poor solution 20 and the leachate solution 30 are mixed together and the inorganic acid 32 is added in an amount to bring the pH to between about 7 and about 8. It should also be noted that, alternatively, only one of the solutions 20 or 30 may be treated in this fashion, depending on the level of fluoride pollution in one or the other or process design considerations.

The recirculation of the PAH-poor solution 20 and the leachate solution 30 enables a looped system to minimize water usage, recuperate value-added fluoride ions, diminish pollutant effluents, among other benefits.

### Embodiments and Aspects of the System

Referring to FIG. 1, the system for treating waste material coming from aluminum production is adapted to perform the process of the present invention. As mentioned above, the waste material contains contaminants comprising PAH and inorganic fluoride compounds containing fluoride ions.

In one embodiment of the system, it includes a flotation vessel for receiving a first liquid and the waste material to produce a waste mixture in it. It also has a surfactant inlet in fluid communication with the flotation vessel for providing a surfactant into the flotation vessel capable of producing PAH-rich micelles in the waste mixture.

There is also a vapor bubbles generator connected to the flotation vessel for generating vapor bubbles in the waste mixture, to produce froth comprising the PAH-rich micelles, as well as a PAH-poor solution and residual solid waste. The vapor bubble generator may be any means useful for such purpose, for example an agitator for generating the vapor bubbles of air in the vessel. The flotation vessel may also be in the form of a column having bottom and top sections and the vapor bubble generator may be a bubble or vapor injector mounted to the bottom section of the column and providing air bubbles thereto. The flotation vessel may have an open top section and be sized to allow the PAH-rich froth to overflow out of the open top section to remove it.

The system further comprising a separation device for separating the PAH-poor solution from the residual solid waste. The separation device may include a decanting vessel, coagulant inlets connected to the decanting vessel for providing coagulants therein and outlets for expelling the residual solid waste and the PAH-poor solution.

The system also includes a stabilization vessel for receiving a second liquid and the residual solid waste, which may come from the decanting vessel. There is also a stabilizer inlet in fluid communication with the stabilization vessel for providing a fluoride ion stabilizer therein to mix with the second liquid and the residual solid waste and to form stabilized fluoride compounds with reduced solubility in the second liquid, to thereby produce decontaminated solids and a leachate solution.

The system may further have a separator, such as a vacuum filter or another kind of solid-liquid separator, for separating the decontaminated solids from the leachate solution.

In one optional embodiment of the system, it further includes a neutralization vessel for receiving the leachate solution and/or the PAH-poor solution. The neutralization vessel includes an inorganic acid inlet for providing an inorganic acid therein to induce precipitation of the fluoride ions remaining in solution, to thereby produce a liquid effluent and a solid residue. There may also be a neutralization separator for separating the liquid effluent from the solid residue.

In another optional embodiment of the system, there is also a recirculation assembly including a conduit connectable to the neutralization vessel for receiving the liquid effluent and connectable to the flotation vessel and/or the stabilization vessel for providing the liquid effluent thereto, and a pump system connected to the conduit for pumping the liquid effluent between the vessels.

The system may also include a size-reduction apparatus, such as a crusher or grinder, for reducing the particle size of the waste material in the flotation vessel. The waste material may be ground to a maximum size of about 1 mm, for instance, before it is fed into the flotation vessel.

### EXAMPLES AND EXPERIMENTATION

The process and the system were developed and are further described in connection with the following examples and experimentation.

### Example 1

### Waste Material

Waste materials from aluminum production were obtained and tested. The waste material was obtained from various sites around the province of Quebec at different dates of the year. The waste material contained different types of waste that are designated as follows:

R_{CU}: waste from electrolytic cells
R_{CR}: waste from melting pots
R_{EP}: waste from purifier cleaning
R_{NC}: waste from cleaning ventilation conduits, dust extractors and floor sweepings
E_{C}04 and E_{C}05: waste mixed of R_{CU}, R_{CR}, R_{EP} and R_{NC}.

The characterization of the waste material samples was done by a metallurgical approach, analyzing the granulometry, granulochemistry and mineralogy.

The granulometry analysis used a screener (Endecott™ Rotap) with screens of different meshes (<0.5, 0.5 to 1.0, 1.0 to 2.0, 2.0 to 8.0, 8.0 to 50 and >50 mm). This separation enabled the determination of the mass distribution of the contaminants in the different fractions of waste material. Before screening, pieces of metal above about 2 mm were removed by visual inspection.

The granulochemistry was analyzed for the different size fractions. A sample of 400 g of each fraction was obtained for R_{CU}, R_{CR}, R_{EP} et R_{NC}, and E_{C}04. The fractions of >50 mm, 8 to 50 mm, and 2 to 8 mm, were ground to about 2 mm before being separated. 100 g of these sub-samples were ground to <30 μm using a Shaterbox™ mill to be able to be submitted to chemical analysis de determine the content of inorganic and organic contaminants. The leftover 300 g were used to determine the hazardous content profile of the waste materials by performing a TCLP test for fluorides and toxic metals for each of the granulometric fractions. The results are summarized in Tables 4 and 5.

TABLE 4
Content of elements (g kg⁻¹ r · s) as a function of
granulometric fractions of E_{C}04

| | | | | | | | Composite |
|---|---|---|---|---|---|---|---|
| | Granulometric fractions (mm) | | | | | | sample |
| Elements | >50 | 8 to 50 | 2 to 8 | 1 to 2 | 0.5 to 1 | <0.5 | (E_{C}04) |
| Al | 317 | 343 | 269 | 270 | 149 | 555 | 250 |
| Ca | 9.8 | 10.1 | 12.6 | 11.0 | 10.4 | 11.1 | 8.7 |
| Cr | 0.7 | 0.3 | 0.3 | 0.4 | 0.3 | 0.1 | 0.2 |
| Fe | 18 | 13 | 59 | 128 | 146 | 131 | 79 |
| Mg | 1.2 | 0.9 | 1.8 | 2.0 | 2.0 | 2.0 | 2.8 |
| Mn | 0.1 | 0.1 | 0.6 | 1.4 | 1.3 | 1.3 | 0.5 |
| Na | 113 | 109 | 142 | 106 | 82 | 92 | 49 |
| P | 5.2 | 3.8 | 2.0 | 0.8 | 0.9 | 0.6 | 2.1 |
| S | 0.0 | 0.0 | 0.3 | 4.0 | 0.5 | 0.4 | 13.4 |
| Ti | 9.4 | 7.7 | 4.1 | 2.5 | 1.7 | 1.3 | 0.0 |
| F | 63 | 83 | 114 | 61 | 55 | 44 | 120 |
| PAF^{a} | — | — | — | — | | — | 251 |

^{a}loss to fire.

TABLE 5
Concentrations of metals (mg L⁻¹) as a function of
granulometric fractions of E_{C}04 from TCLP tests on
different samples of waste material

| | | | | | | | | |
|---|---|---|---|---|---|---|---|---|
| Waste | Granulo. (mm) | As | Ba | B | Cd | Cr | Pb | Se |

| | | | | | | | | |
|---|---|---|---|---|---|---|---|---|
| R_{CU} | >50 | 0.00 | 0.58 | 0.13 | 0.00 | 0.00 | 0.00 | 0.04 |
| | 8 to 50 | 0.00 | 0.50 | 0.11 | 0.00 | 0.00 | 0.01 | 0.02 |
| | 2 to 8 | 0.00 | 0.69 | 0.15 | 0.00 | 0.00 | 0.00 | 0.03 |
| | 1 to 2 | 0.00 | 0.84 | 0.12 | 0.00 | 0.00 | 0.00 | 0.00 |
| | 0.5 to 1 | 0.00 | 0.57 | 0.08 | 0.00 | 0.00 | 0.01 | 0.00 |
| | <0.5 | 0.00 | 0.38 | 0.09 | 0.01 | 0.00 | 0.00 | 0.05 |
| R_{CR} | >50 | 0.00 | 0.50 | 0.11 | 0.00 | 0.00 | 0.01 | 0.03 |
| | 8 to 50 | 0.00 | 0.24 | 0.06 | 0.01 | 0.00 | 0.00 | 0.03 |
| | 2 to 8 | 0.00 | 0.59 | 0.05 | 0.02 | 0.00 | 0.00 | 0.03 |
| | 1 to 2 | 0.00 | 0.52 | 0.06 | 0.03 | 0.01 | 0.00 | 0.03 |
| | 0.5 to 1 | 0.00 | 0.42 | 0.07 | 0.04 | 0.00 | 0.00 | 0.06 |
| | <0.5 | 0.00 | 0.12 | 0.00 | 0.28 | 0.08 | 0.05 | 0.08 |
| R_{EP} | >50 | 0.00 | 0.22 | 0.00 | 0.00 | 0.00 | 0.00 | 0.00 |
| | 8 to 50 | 0.00 | 0.42 | 0.01 | 0.00 | 0.00 | 0.01 | 0.03 |
| | 2 to 8 | 0.00 | 0.30 | 0.24 | 0.07 | 0.01 | 0.11 | 0.06 |
| | 1 to 2 | 0.00 | 0.09 | 0.08 | 0.14 | 0.01 | 0.09 | 0.04 |
| | 0.5 to 1 | 0.00 | 0.06 | 0.21 | 0.17 | 0.00 | 0.07 | 0.09 |
| | <0.5 | 0.00 | 0.05 | 0.08 | 0.14 | 0.00 | 0.04 | 0.08 |
| R_{NC} | >50 | 0.00 | 0.07 | 0.56 | 0.00 | 0.00 | 0.10 | 0.05 |
| | 8 to 50 | 0.00 | 0.07 | 1.23 | 0.00 | 0.00 | 0.00 | 0.00 |
| | 2 to 8 | 0.00 | 0.12 | 1.61 | 0.00 | 0.01 | 0.02 | 0.13 |
| | 1 to 2 | 0.00 | 0.13 | 1.68 | 0.00 | 0.00 | 0.03 | 0.09 |
| | 0.5 to 1 | 0.00 | 0.09 | 1.41 | 0.00 | 0.00 | 0.08 | 0.10 |
| | <0.5 | 0.00 | 0.12 | 2.07 | 0.01 | 0.01 | 0.04 | 0.07 |
| Norm | | 5.0 | 100 | 500 | 0.5 | 5.0 | 5.0 | 1.0 |
| TCLP | | | | | | | | |

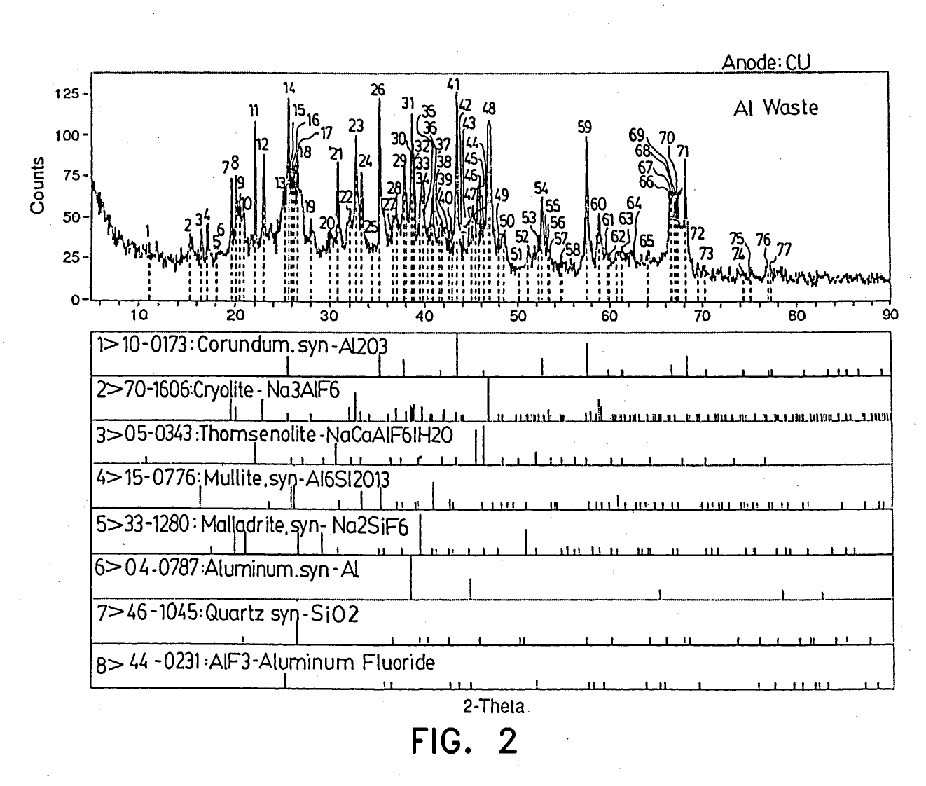

The mineralogical analysis enabled the determination of the mineralogical phases present in the waste material. It was performed by X-ray diffraction and by electron microscope observations. FIG. 2 shows an X-ray diffraction graph for E_{C}04, which reveals that the predominant mineral phases are cryolite (Na₃AlF₆), pachnolite, thomsenolite (NaCaAlF₆), and aluminum oxide (Al₂O₃).

### Example 2

### Preliminary Leaching Tests

Leaching tests were performed on the waste material to determine the leachable fluoride content at different conditions. Acidic leaching was done in a beaker with agitation in which pre-ground E_{C}04 pre-ground to <2 mm was placed with 1 L of water. The pH was adjusted with H₂SO₄ 1.8 M to 1.5, 2.0, 2.5, 3.0 and 5.0 with different waste solid concentrations of 16, 12, 10, 8, 4, 2, and 1% p v⁻¹. Three successive leaching steps were done (LA₁, LA₂, et LA₃) for 30 minutes at ambient temperature. After each leaching step, the samples were filtered under vacuum.

The results of the TCLP tests done on the treated samples indicated fluoride ion concentration between 400 and 500 mg L⁻¹, which is above the prescribed standard (<150 mg F⁻L⁻¹) and the three successive Teachings were thus not sufficient to meet this standard.

### Example 3

### Stabilisation Tests

Two types of tests were performed for the chemical stabilization of the aluminum production waste material. One looked at the combined action of Na₂SO₄ et (Al₂(SO₄)₃.18H₂O on the fluoride ions and the other looked at the action of using Ca(OH)2. The tests were done using glass stirred reactors of 2 L capacity and containing a volume of 1 L of a suspension of 10% p v⁻¹ waste material E_{C}04, that is a concentration of 100 g L⁻¹.

The test using Na₂SO₄ et (Al₂(SO₄)₃.18H₂O were done by adding Al³⁺ and Na⁺ so that their respective number of moles was equal to 1.0, 2.0, 3.0 and 4.0 times the theoretical number required for forming cryolite (Na₃AlF₆, K_{PS}=10^{-33.84}), knowing that the leachable fraction of fluoride ions was estimated at 0.59 L⁻¹. This leachable fraction of fluoride ions had been previously determined from TCLP tests on the untreated waste material. Thus, concentrations between 0.93 and 3.74 g L⁻¹ of NaSO₄ and concentrations between 1.46 and 5.85 g L⁻¹ of Al₂(SO₄)₃.18H₂O were used assuming a fluoride ion concentration of 0.5 g L⁻¹ in solution. After 120 minutes of treatment a solid-liquid separation step was performed by vacuum filtration (Whatman membrane 934-AH porosity 1.5 μm). The results are summarized in Table 6.

TABLE 6
Treatment and et stabilization of E_{C}04 waste material by
Al₂(SO₄)₃ and Na₂SO₄

| | |
|---|---|
| Without prewashing with water | With prewashing with water |

| Parameters | CONT-1 | E-1 | E-2 | E-3 | E-4 | E-5 | E-6 | E-7 | E-8 |
|---|---|---|---|---|---|---|---|---|---|
| Reactants added | | | | | | | | | |
| Na₂SO₄ (100% Na⁺) | 0 | 303 | 605 | 908 | 1210 | 303 | 605 | 908 | 1 210 |
| (mg L⁻¹) | | | | | | | | | |
| Al₂(SO₄)₃ (100% Al⁺³) | 0 | 118 | 237 | 355 | 473 | 118 | 237 | 355 | 473 |
| (mg L⁻¹) | | | | | | | | | |
| Molar ratio [F/Na/Al] | — | [6/3/1] | [6/6/2] | [6/9/3] | [6/12/4] | [6/3/1] | [6/6/2] | [6/9/3] | [6/12/4] |
| Final pH | 6.4 | 5.7 | 5.3 | 4.8 | 4.7 | 5.7 | 5.3 | 4.9 | 4.5 |
| Dehydration filtrates | | | | | | | | | |
| Na⁺ (mg L⁻¹) | 174 | 585 | 986 | 1 461 | 1 608 | 381 | 799 | 1 427 | 1 623 |
| Al³⁺ (mg L⁻¹) | 25 | 185 | 357 | 581 | — | 168 | 337 | 631 | — |
| Molar ratio (Na/Al) | 8.27 | 3.77 | 3.24 | 2.95 | — | 2.66 | 2.78 | 2.65 | — |
| Leachate emitted from | | | | | | | | | |
| TCLP test | | | | | | | | | |
| F⁻ (mg L⁻¹) | 222 | 141 | 141 | 226 | 230 | 140 | 140 | 250 | 215 |

### DL Detection Limit

The reduction of the leachable portion of fluoride ions measured for tests E-1 to E-6 may be explained by the adjustment of the pH, such parameter considerably influencing the solubility of the fluoride and aluminum ions. The fluoride salts are more soluble at higher pH. It should be noted that the addition of Al₂(SO₄)₃.18H₂O contributed to the acidification of the suspension, causing the pH to go from a range of 6.2-6.5 to a range of 5.7-4.5 depending of the quantity of Al₂(SO₄)₃ added. According to the results of Table 5, the final pH values between 5.3 and 5.7 are when the leachable portion of the fluoride ions was inferior to the TCLP standard. Thus, for treatment with Na₂SO₄ and Al₂(SO₄)₃, the availability of fluoride ions seems to be related to the final pH during the treatment.

### Example 4

### Stabilization with Ca(OH)₂

The other stabilization test used lime Ca(OH)₂. They were done at different concentrations of lime of 10 to 16 g L⁻¹ while maintaining rapid agitation of 200 to 300 rotations per minute (rpm) during 30, 60 and 120 min. Once stabilized and dehydrated, the solid fraction was recovered and maintained at ambient temperature for 48 h (<<curing>> time) to further promote the stabilization reaction of the waste material. TCLP tests were then done. Control tests were also done in a parallel manner to compare treated and untreated samples. The results are shown in Table 7.

TABLE 7
Stabilization of E_{C}04 waste by Ca(OH)₂

| | Test | | | | | | | |
|---|---|---|---|---|---|---|---|---|
| Parameters | CONT-2 | E-9 | E-10 | E-11 | E-12 | E-13 | E-14 | E-15 |
| Ca(OH)₂ (g L⁻¹) | 0 | 2 | 4 | 8 | 10 | 12 | 14 | 16 |
| Final pH (after 120 min) | 6.5 | 10.3 | 11.3 | 11.9 | 12.0 | 12.1 | 12.1 | 12.1 |

Concentrations of F⁻ (mg L⁻¹) in solution during the lime wash

| | | | | | | | | |
|---|---|---|---|---|---|---|---|---|
| After 30 min | 126 | 151 | 61 | 36 | 32 | 13 | 7 | 15 |
| After 60 min | 135 | 196 | 89 | 77 | 92 | 32 | 15 | 38 |
| After 120 min | 150 | 280 | 345 | — | 210 | 412 | 142 | 60 |

Leachate emitted from TCLP test after 120 minutes of treatment

| | | | | | | | | |
|---|---|---|---|---|---|---|---|---|
| Final pH | 5.4 | 5.4 | 5.5 | 5.7 | 5.6 | 5.6 | 4.6 | 5.0 |
| Concentration of F⁻ (mg L⁻¹) | 235 | 185 | 176 | 151 | 115 | 110 | 516 | 580 |

This series of tests used lime (Ca(OH)₂) to sequester fluoride ions in the form of CaF₂ (Kₚₛ=10^{-10.5}) by adding concentrations between 2 and 16 g L⁻¹. The results show the stabilizing effect of Ca(OH)₂ on the waste E_{C}, notably for experiments E-12 and E-13 at the exit of which the measured fluoride content between 115 and 110 mg F⁻ L⁻¹ in the TCLP leachate was below the standard's toxicity limit of 150 mg L⁻¹. It is noted that the leachable portion of the fluoride ions (185 à 110 mg F⁻ L⁻¹) was decreased as the concentration of Ca(OH)2 increased (2 à 12 g L⁻¹ of Ca(OH)₂), notably for experiments E-9 to E-12 for which the same extraction fluid No. 1 (which had a fixed pH of 4.93) was used during the TCLP tests. On the other hand, when the extraction fluid No. 2 (pH 2.88) was used, given the basicity of the treated waste, notably for experiments E-14 and E-15, the leachable portion of the fluoride ions increased, up to 580 mg L⁻¹, which is more than three times the TCLP norm.

The measurements of fluoride ion concentration in solution during the treatment indicated the increase of these ions with the washing time (30, 60 and 120 min) for all concentrations of Ca(OH)₂. Such a result signifies that the application of Ca(OH)₂ acted in a sequential fashion on the waste causing a rapid sequestration of the available fluoride ions available in solution. A MINEQL+ modelling enabled the prediction of the speciation of the fluoride ions during the sequestration phenomenon. The concentrations of the chemical species Al, F, Na and S were chosen for the modelling keeping in mind the initial concentrations measured in the liquid fraction obtained following the Ca(OH)₂ washing. The MINEQL+ simulation under modelling conditions pH=12, [Ca(OH)₂]=0.25 M, null ionic force, 25° C.) revealed that fluorides were found in majority in the form CaF₂. There was sequestration of the F⁻ ions by calcium ions (Ca²⁺), according to the following equation:

F⁻+2Ca²⁺→CaF₂

Rapid sequestration occurs in the first 30 min followed by leaching phenomena from 30 to 120 min. The Ca(OH)₂ treatment enables the efficient stabilization of the E_{C}04 waste material notably for concentrations of Ca(OH)₂ between 10 and 12 g L⁻¹. The leaching was characterized by an increase in the concentration of fluoride ions in the leachate. In the experiment E-12 (10 g L⁻¹), the fluoride ion concentration in the washing solutions increased from 32 to 210 mg L⁻¹. This increase in solubility of the fluoride ions is likely due to the dissociation of the cryolite and the pachnolite or thomsenolite. These generally water-insoluble fluorides are dissociated in highly basic environments. In complementary tests on the solubility of cryolite in the presence of 10 g L⁻¹ Ca(OH)2, the analyses of the liquid fractions obtained after 2 h of agitated contact, and after filtration, showed 2.5% fluoride ions relative to the total quantity of fluorides. Surely, the two observed phenomena (sequestration and leaching) enable efficient stabilization of the E_{C}04 waste notably for 10 et 12 g L⁻¹ Ca(OH)2 concentrations.

### Example 5

### Recuperation of Fluoride Ions

Tests were done on leachate emitted from the decontamination of waste material. These tests were done in glass agitated reactors having a capacity of 2 L and useable volume of 1 L. The leachates were treated in neutral medium (pH 7.0) and in basic medium (pH 8.5 and 10), in the presence or not of precipitating agent Al₂(SO₄)₃.14H₂O (known as alum), added so that the number of moles of Al³⁺ equal to 1.0 and 2.0 times the theoretical number of moles required in the reaction between F⁻ and Al³⁺ leading to the formation of AlF₃). The pH was adjusted using H₂SO₄ 10 N, or a solution of NaOH, 50 g L⁻¹. The treatment was applied over a period of 60 min. Over the course of the tests, samples of 10 mL were removed at different times (0 min before adding the precipitating agent, 10, 20, 40 and 60 min) to observe the evolution of the residual concentration of fluoride ions in solution. After each test, the suspension was decanted for about 18 h. The residual concentration of fluoride ions was determined in the liquid fraction, while the quantity of dry mass of the precipitate was measured after a prior filtration of the suspension. The results are shown in Table 8.

TABLE 8
Precipitation of fluoride ions of leachates emitted from the
stabilization of waste material E_{C}04

| | Experiment | | | | | | | | |
|---|---|---|---|---|---|---|---|---|---|
| Parameters | G-1 | G-2 | G-3 | G-4 | G-5 | G-6 | G-7 | G-8 | G-9 |
| Al³⁺ added (mg L⁻¹) | 20 | 20 | 20 | 40 | 40 | 40 | 0 | 0 | 0 |
| Molar ratio [F/Al] | [3/1] | [3/1] | [3/1] | [3/2] | [3/2] | [3/2] | — | — | — |
| pH initial | 11.9 | 11.9 | 12.0 | 12.0 | 12.0 | 11.9 | 12.1 | 12.0 | 12.0 |
| pH final | 7.0 | 8.4 | 11.9 | 7.1 | 8.4 | 11.0 | 7.1 | 8.4 | 11.0 |
| F⁻ initial (mg L⁻¹) | 47 | 43 | 42 | 43 | 43 | 44 | 44 | 43 | 44 |
| F⁻ residual (mg L⁻¹) | 4 | 7 | 4 | 4 | 8 | 43 | 4 | 8 | 43 |
| Fluoride removal (%) | 91.5 | 84.0 | 91.0 | 91.0 | 81.5 | 2.25 | 91.0 | 82.0 | 2.25 |
| Mass of dry waste (g L⁻¹) | 0.76 | 0.73 | 0.01 | 0.82 | 0.81 | 0.72 | 0.65 | 0.67 | 0.02 |

The dehydration of the stabilized waste generates a leachate containing a high concentration of fluoride ions, which must be treated before it is emitted into the environment. Precipitation tests were performed to recuperate these ions in the form of AlF₃, such reactant being used for the neutralization of Na₂O in the electrolytic bath in aluminum production. To do so, the leachate from the dehydration of the waste stabilized with Ca(OH)2 was treated at different pH (7.0 to 11.0) in the presence of one or more precipitating agent Al₂(SO₄)₃.14H₂O (alum). Using Al₂(SO₄)₃.14H₂O aimed to further enrich the leachate with Al ions to promote formation of AlF₃ (Kₚₛ=10^{-16.7}) according to the following reaction:

3F⁻+Al³⁺ [symbol] AlF₃

Concentrations of 20 and 40 mg Al L⁻¹ were added to the leachate so that the number of moles of Al was respectively equal to 1.0 and 2.0 times the theoretical number of moles required for the reaction of F⁻ et Al³⁺ ions to form AlF₃ according to the molar rations ([F/Al]), [3/1] and [3/2]. The results of these tests (G-1 to G-6) were compared to those of tests G-7, G-8 and G-9 where no Al ions were added. Comparison shows that adding alum was not necessary for reducing the fluoride ion concentration in the leachate. Thus, simply reducing the pH to between 7.0 and 8.5 by adding sulfuric acid was shown to be sufficient for reducing the initial concentration of fluoride ions (43 to 44 mg L⁻¹) to final values of 4.0 and 8.0 mg L⁻¹ (in tests G-7 and G-8, respectively). In addition, the residual concentration of fluoride ions was almost identical to the initial values before treatment for tests G-6 and G-9, for which the final pH varied between 11.9 and 11.0. Thus, at a pH of 11, the aluminum in solution in present in the predominant form Al(OH)₄⁻ which promotes the electrostatic repulsion of the negative charges of these ions with the negatively charged fluoride ions.

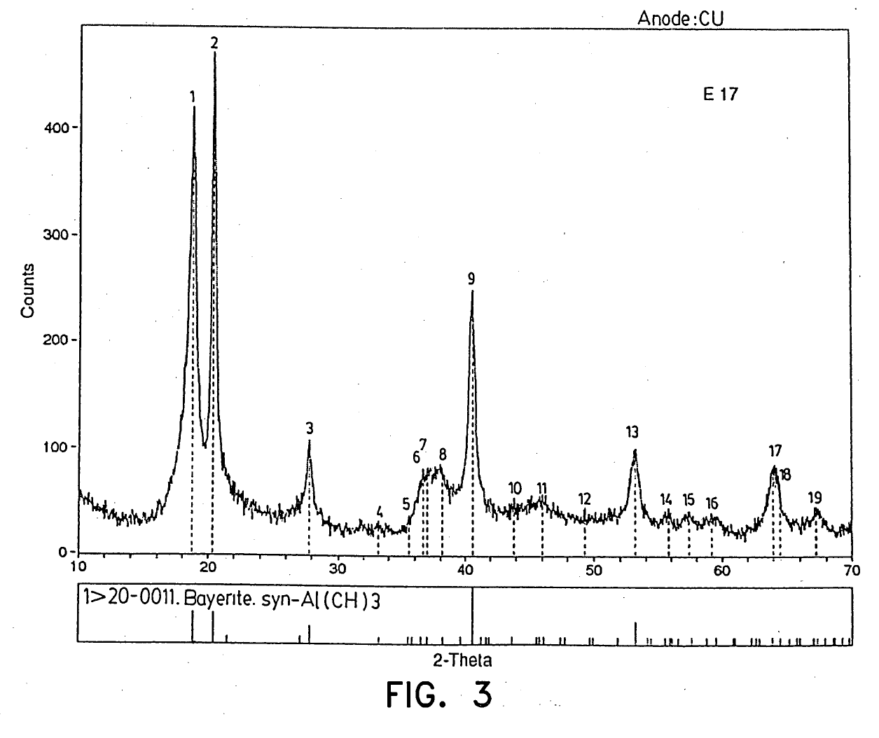

The decantation and subsequent dehydration of the suspension enabled measuring the mass on a dry basis of the solid precipitate formed. This mass increased as the residual concentration of fluoride ions decreased. This result signifies that fluoride ions precipitated or co-precipitated with other ions present in solution. Complementary tests were done in view of determining the form in which the fluoride ions precipitated. These tests were done on a filtrate of the dehydration coming from the stabilization of E_{C}04 waste The treatment of the filtrate was done at pH 7.0 (without alum addition). The initial and final concentrations of the Al and F ions were measured, followed by a DRX analysis. Initial concentrations of Al and F were respectively 277 and 92 mg L⁻¹. Final concentrations were respectively 1.0 and 3.0 mg L⁻¹, corresponding to a reduction of 99% of Al and 98% of F. The X-ray diffraction analysis of the precipitate revealed however the majority presence of Al(OH)₃, as per FIG. 3. This shows that Al ions were dominant in the solution compared to fluoride ions.

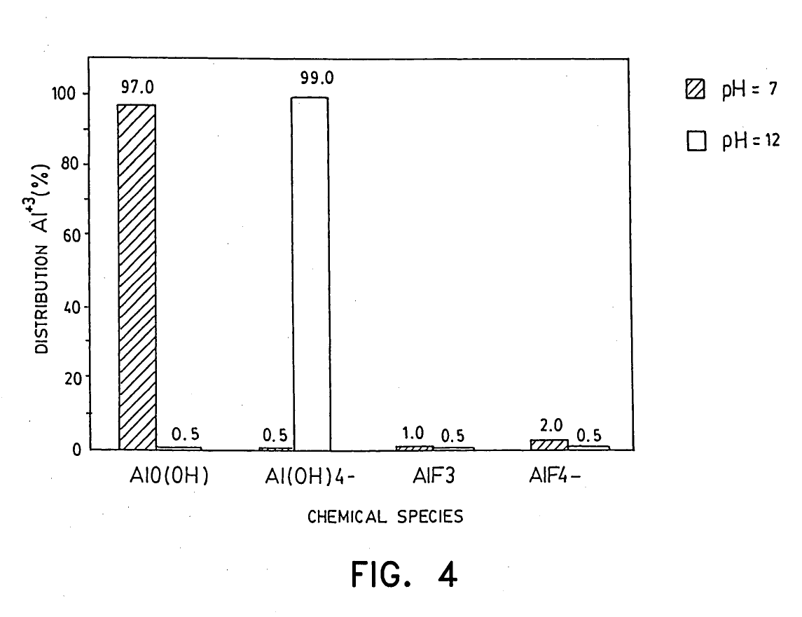

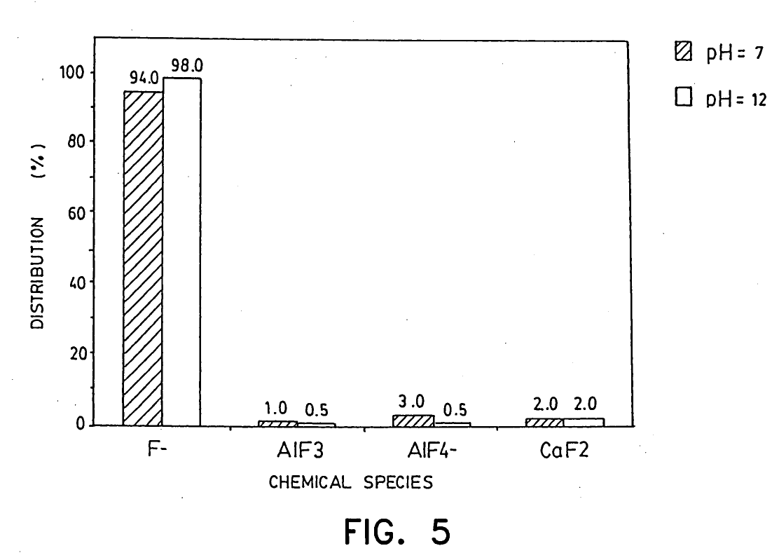

Another approach used modelling with the chemical equilibrium software MINEQL+ (version 4.5) to predict the probable repartition of free ions, soluble complexes and precipitates formed depending on the pH and the total concentration of different constituents of the system. The results showed an absence of Al(OH)₃ precipitate and the presence of other solid phase forms. The results are summarized in FIGS. 4 and 5. The modelling results do not explain the precipitation of the fluorides since according to its prediction more than 93% would be soluble in ion form at a pH of 7. The diaspore is an aluminum oxyhyroxyde that is formed during the acidification of the leachate according to the following reaction:

Al(OH)₄⁻+H⁺ [symbol] AlO(OH)+2H₂O

The F⁻ ion has a similar size to OH⁻ groups and consequently could easily substitute in Al complexes. The elimination of fluoride ions in solution would thus be explained by a reaction between the fluoride ions and the aluminum hydroxides by co-precipitation as per the above reaction, and by adsorption on the aluminum hydroxide as per the following reaction:

Al³⁺+(3-m)HO⁻+mF⁻ [symbol] ^{AlF}ₘ(OH)₍₃₋ₘ₎;

and probably also forming hydroxy-aluminoflurides for instance according to the following reaction:

Al(OH)₃+mF⁻ [symbol] AlFₘ(OH)₍₃₋ₘ₎+mHO⁻

The elevated surface of newly formed aluminum hydroxides newly formed over the course of the precipitation reaction allows adsorption of the fluoride ions in solution.

### Example 6

### PAH Removal Tests

The samples were prepared by obtaining 1 kg of aluminum production waste material according to the mass percentages of the granulometric fractions (8 to 50 mm, 2 to 8 mm, 1 to 2 mm, 0.5 to 1.0 mm and <0.5 mm), previously obtained by the granulometric analysis of sample E_{C}04. The kilogram of waste was transferred to a glass bottle to then be placed on a rotary wheel for 45 min at a speed of 30 rpm to obtain a homogeneous sample. Then, the waste was subjected to a sample splitter to obtain representative sub-samples. The PAH decontamination tests were done on these sub-samples.

### Surfactant Treatments

The waste material was washed using different types of non ionic and zwitterions surfactants. The test were done at ambient temperature of 22±2° C. by placing in 2 L glass beakers 100 g of E_{C}04 waste that had been previously ground to a granulometry below 8 mm, in a volume of 1.0 L of tap water (ST=10% p v⁻¹). The resulting pulp mixtures were agitated with an axial type helice for 60 min in the presence of 0.5% (p p⁻¹ on a dry basis) different types of non ionic surfactants (Tween 80 and Triton X-100) and zwitterion surfactants (CAS and BW). The four surfactants were from Sigma-Aldrich™. They were used directly without any other previous purification. The characteristics of these surfactants are laid out in Table 9.

TABLE 9
surfactant characteristics

| | | MM | CMC^{a} | |
|---|---|---|---|---|
| Usual name | Chemical structure | (g mol⁻¹) | (mg L⁻¹) | HLB^{b} |
| Triton X-100 | 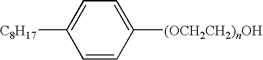 | 625 | 130 | 13.5 |
| | n~10 | | | |
| Tween 80 | 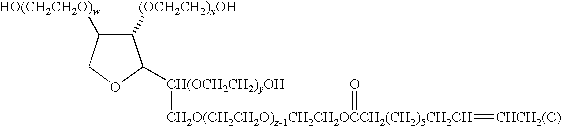 | 1310 | 33-45 | 15 |
| | w + x + y + z = 20 | | | |
| CASCocoamidoporopylhydroxysultaine | 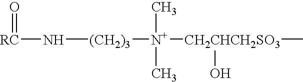 | 419 | | |
| | R = C₁₂H₂₅ | | | |
| BWCocoamidopropylbetaine | 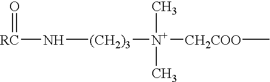 | 356 | | |

^{a}Critical micelle concentration
^{b}Hydrophobic-lipophobic balance

During the washing step, the separation of the humid solid phase from the liquid phase was done by vacuum filtration with a Whatman (Qualitative 114, porosity of 25 μm). An aliquot of the humid solid fraction of the treated waste was removed in a manner to perform the PAH extraction. The electric charge of the surfactants depends on the pH of the solution. The surfactants were added at 0.5% (p p⁻¹), above the critical micelle concentration of each surfactant, to promote the formation of micelles and the solubilization of PAH. The pH values obtained were between 6.3 and 6.5. The results of these tests are shown in Table 10.

TABLE 10
Removal of PAH with washing of
E_{C}04 (ST = 10% (p v⁻¹); t = 60 min) with
different surfactants at a concentration of 0.5% (p p⁻¹)

| | Surfactants (non ionic) | | | | Surfactant (amphoteric) | |
|---|---|---|---|---|---|---|
| | Tween 80 | | Triton X-100 | | CAS | |
| | Final Conc. | Removal | Final Conc. | Removal | Final conc. | Removal |
| PAH | (mg kg⁻¹) | (%) | (mg kg⁻¹) | (%) | (mg kg⁻¹) | (%) |
| Benzo(a)anthracene | 180 | 0 | 70 | 36 | 150 | 13 |
| Benzo(a)pyrene | 190 | 24 | 180 | 25 | 185 | 27 |
| Benzo(b,j,k)fluoranthene | 770 | 10 | 620 | 25 | 550 | 35 |
| Chrysene | 430 | 3 | 250 | 24 | 270 | 38 |
| Dibenzo(a,h)anthracene | 75 | 33 | 130 | 40 | 115 | 0 |
| Fluoranthene | 50 | 6 | 30 | 27 | 50 | 5 |
| Indeno(1,2,3-cd)pyrene | 175 | 33 | 410 | 19 | 220 | 15 |
| Pyrene | 80 | 13 | 45 | 30 | 75 | 17 |

It is noted that at the tested conditions the BW surfactant had no effect on the PAH recuperation and removal. During the washing, the pH close to neutral promoted the amphoteric form of BW. Nevertheless, the proximity of the two ionic groups of BW lead to a neutralization of the charges. Thus, the BW surfactant acted like a non ionic surfactant. This neutralization would have an influence on the CMC of the surfactant and its capacity to solubilize the PAH compounds.

The characterization of the organic pollutants revealed that nine distinct PAH molecules were present in concentrations varying from 60 à 1 010 mg kg⁻¹ in the E_{C}04 waste material. The PAH molecules present were fluoranthene, pyrene, benzo(a)anthracene, chrysene, benzo(a)pyrene, BJK, dibenzo(a,h)anthracene and indeno(1,2,3-cd)pyrene.

The washing with Tween 80 resulted principally in the removal of six ring indeno(1,2,3-cd)pyrene, and five ring dibenzo(a,h)anthracene and benzo(a)pyrene, in the respective percentages of 33%, 33% and 25%. The percentage of BJK removal was only 10% despite a high initial concentration of BJK in the matrix. There is competition between the BJK and the three other strongly hydrophobic organic compounds for incorporation into the micelles of Tween 80. The large hydrocarbon chain of Tween 80 seems to result in the large removal of these compounds.

The Triton X-100 that has a shorter hydrocarbon chain than Tween 80 allow preferential incorporation of dibenzo(a,h)anthracene (40% removal) into its micelles.

The use of CAS that has an even shorter hydrocarbon chain than Triton X-100 allowed the highest removal of BJK, benzo(a)pyrene and chrysene. CAS was first used in the cosmetics industry for producing shampoos. The results of this study and various examples herein show that the use of CAS for removing PAH compounds is advantageous.

The intermolecular space between the N⁺ and SO₃⁻ groups of sulfobetaine compounds has been shown to be sufficiently large (6-7 Å) to accommodate pyrene molecules (Lianos and Zana 1981; Pandey et al. 1998). In addition to the core of the micelle, CAS's structure has supplementary space to fix hydrophobic molecules.

The results indicate that the performance of a surfactant to mobilize and thus remove organic contaminants depends on its nature and structure as well as its degree of reactivity with the matrix and the PAH molecules. Another important factor may be the volume fraction occupied by the organic compounds in the micelle, this volume depending on the length of the hydrocarbon chain of the surfactant and the size of the organic molecule. Another factor may be that PAH molecules interact with each other, based on their intrinsic properties notably their partition coefficient Ko/w. The more hydrophobic PAHs (high Ko/w) will form energetically stronger bonds with the interior of the micelles.

### Example 7

### CAS Washing Tests

Another series of washing tests was performed in triplicate in similar conditions (ST=10% p v⁻¹) but using only the CAS surfactant at a concentration of 0.5% (p p⁻¹). During the 60 min washing, two separation techniques were used to separate the solid and liquid fractions: vacuum filtration with a Whatman (Qualitative 114) and centrifugation (Allegra™ 6 Centrifuge, model Beckman Clouter) at a speed of 500×g (1 480 rpm) during 1 h. The results are shown in Tables 11 and 12.

TABLE 11
Removal of PAH from E_{c}04 waste
(ST = 10% (p v⁻¹); t = 60 min) with
CAS (0.5% p p⁻¹) as a function of the
physical separation (filtration, centrifugation, flotation)

| | Filtration | | Centrifugation | | Flotation | |
|---|---|---|---|---|---|---|
| | Conc. final | Removal | Conc. final | Removal | Conc. final | Removal |
| PAH | (mg kg⁻¹) | (%) | (mg kg⁻¹) | (%) | (mg kg⁻¹) | (%) |
| Benzo(a)anthracene | 155 ± 4 | 12 | 160 ± 34 | 5 | 60 ± | 65 |
| Benzo(a)pyrene | 225 ± 56 | 7 | 230 ± 24 | 27 | 130 ± 16 | 38 |
| Benzo(b,j,k)fluoranthene | 770 ± 309 | 19 | 910 ± 53 | 26 | 550 ± 65 | 46 |
| Chrysene | 360 ± 124 | 25 | 450 ± 70 | 14 | 290 ± 23 | 45 |
| Dibenzo(a,h)anthracene | 135 ± 24 | 0 | 155 ± 24 | 0 | 85 ± 29 | 32 |
| Fluoranthene | 50 ± 0 | 8 | 50 ± 9 | 0 | 30 ± 4 | 47 |
| Indeno(1,2,3-cd)pyrene | 310 ± 127 | 0 | 335 ± 82 | 1 | 185 ± 61 | 34 |
| Pyrene | 80 ± 7 | 12 | 80 ± 20 | 4 | 40 ± 7 | 51 |

The different separation techniques (filtration, centrifugation and flotation) were compared to a simple washing step in the presence of CAS, to determine the net improvement in the PAH removal percentage. The increased yield of flotation is related to the injection of air performed during flotation, which promotes the transport of the micelles to the air-liquid interface, but also that of the hydrophobic particles. The micelles containing organic and hydrophobic molecules accumulate at the surface of the pulp and are recuperated in the concentrate.

### Example 8

### Flotation with CAS Tests

The waste material was treated by flotation at ambient temperature in a flotation cell (Wemco Agitair) containing a volume of 1 L. Masses of 100 g of E_{C}04 samples pre-ground to a granulometry below 8 mm were put in 1 L of water (ST=10% p v⁻¹) along with a concentration of CAS. Conditioning of the pulp was done for 60 min under mechanical agitation of 1800 rpm. After this, the flotation was performed with air injection from an air inlet into the cell for about 7 min. This first flotation was followed by a second one for 5 min and then a third one for 2 min. After the first flotation, each subsequent flotation was separated by another conditioning step for 10 min. After each flotation, the froth (also referred to as concentrate or skimmings of foam and air) formed at the surface of the pulp and above the flotation cell was collected by overflow into a container designed for that purpose. After the third flotation, the non-floated material or the remaining pulp constituted the reject. The froth/concentrates and the rejects were dried for 48 h at 60° C. After drying the masses, the froth/concentrates and the rejects were analyzed.

The effect of the CAS concentration was observed. The results are summarized in Table 12.

TABLE 12
Removal of PAH from composite sample by flotation
(ST = 10% (p v⁻¹); t = 7, 5, 2 min)
as a function of CAS concentration

| | | Concentration CAS | | |
|---|---|---|---|---|
| | | (% p p⁻¹) | | |
| Parameters | PAH | 0.20 | 0.25 | 0.50 |
| PAH removal (%) | Benzo(a)anthracene | 25 | 61 | 56 |
| | Benzo(a)pyrene | 30 | 54 | 56 |
| | Benzo(b,j,k)fluoranthene | 24 | 45 | 49 |
| | Chrysene | 24 | 45 | 44 |
| | Dibenzo(a,h)anthracene | 27 | 99 | 61 |
| | Fluoranthene | 99 | 56 | 57 |
| | Indeno(1,2,3-cd)pyrene | 16 | 48 | 53 |
| | Pyrene | 28 | 60 | 58 |
| Production of rejects (%) | | 5 | 18 | 32 |

A series of tests were done by flotation in the presence of CAS at different concentrations (0, 0.1, 0.2, 0.25 and 0.5% p p⁻¹). The tests done with 0.1% formed very little froth thus hindering the recuperation of the froth by overflow. It may be that the higher the CAS concentration, the more solubilized PAH are obtained. However, the increase in removal seemed to stabilize at 0.5% CAS at the given concentration of the pulp. The tendency of the removal percentage toward a plateau as a function of CAS concentration is likely due to parasitic entrainment or to mass loss caused during the flotation process.

Table 12 also shows that the production of dangerous rejects increases with increasing surfactant concentration. This shows that higher concentrations ameliorate the liquid-air transfer phenomena between of the hydrophobic compounds. The foaming properties are at the origin of this phenomenon. An increase in the dose of CAS would promote an increase in the foam volume during the air injection at the liquid-air interface and, consequently, of the volume of the concentrate generated. Consequently, considering PAH removal and the minimization of producing dangerous reject, an optimal concentration of CAS may be about 0.25% (p p⁻¹). This concentration was retained for further experimentation.

### Example 9

### Flotation Tests and Waste Content

Another series of flotation tests were done with different concentrations of waste material in the pulp mixture (ST=7, 10, 15 and 20% p v⁻¹) and with CAS concentration of 0.25% (p p⁻¹). The results are shown in Table 13.

TABLE 13
Removal of PAH for flotation of composite waste material
with CAS (0.25% (p p⁻¹); t = 7, 5, 2 min) as a
function of the concentration of the solids in the pulp mixture

| | | Total solids | | |
|---|---|---|---|---|
| | | (% p p⁻¹) | | |
| Parameters | PAH | 10 | 15 | 20 |
| Removal of PAH (%) | Benzo(a)anthracene | 61 | 34 | 43 |
| | Benzo(a)pyrene | 48 | 36 | 40 |
| | Benzo(b,j,k)fluoranthene | 54 | 57 | 47 |
| | Chrysene | 45 | 45 | 34 |
| | Dibenzo(a,h)anthracene | 99 | 33 | 53 |
| | Fluoranthene | 56 | 27 | 33 |
| | Indeno(1,2,3-cd)pyrene | 16 | 13 | 49 |
| | Pyrene | 60 | 39 | 33 |
| Production of reject (%) | | 17 | 10 | 14 |

It is also noted that the flotation test with 7% solid waste material showed no PAH removal since the recuperation of the concentrates of flotation was almost zero. The highest removal of BJK was obtained with a solids concentration of 15%.

### Example 10

### Reproducibility of Flotation Tests

Flotation tests were done in triplicate in optimal conditions, including three flotation steps (t=7, 5 et 2 min) with a CAS concentration of 0.25% (p p⁻¹) and a solids content of 15% (p v⁻¹), to determine reproducibility.

FIG. 6 shows such an embodiment.

Table 14 shows the initial and final PAH content results along with removal yields.

TABLE 14
Removal of PAH by flotation (ST = 15% (p v⁻¹); t = 7, 5, 2 min)
with CAS (0.25% p p⁻¹)^{a}

| | Conc. initial | Conc. final | Removal |
|---|---|---|---|
| PAH | (mg kg⁻¹) | (mg kg⁻¹) | (%) |
| Benzo(a)anthracene | 210 ± 96 | 65 ± 29 | 62 |
| Benzo(a)pyrene | 155 ± ±4 | 70 ± 55 | 31 |
| Benzo(b,j,k)fluoranthene | 1 200 ± 180 | 380 ± 164 | 68 |
| Chrysene | 555 ± 28 | 200 ± 60 | 63 |
| Dibenzo(a,h)anthracene | 115 ± 46 | 70 ± 22 | 36 |
| Fluoranthene | 105 ± 33 | 50 ± 19 | 45 |
| Indeno(1,2,3-cd)pyrene | 275 ± 100 | 165 ± 57 | 34 |
| Pyrene | 130 ± 37 | 60 ± 12 | 50 |

^{a}Average production of dangerous reject equal to 10% (p p⁻¹).

It is noted that BJK initial concentration of 1 200±180 mg kg⁻¹ was above the norm established by the Ministère de l'Environnement du Québec, and after treatment the BJK was well below the norm.

### Example 11

### Looped Process Embodiment

Samples of non treated aluminum production waste material (NAW) from the E_{C}05 sample was transferred to a glass bottle and then a rotary wheel for 24 h at 30 rpm to obtain a homogeneous sample. Then the samples were separated by a sample splitter to obtain sub-samples of 150 g, which were tested.

The looped process was divided into three phases:

1) extraction of organic contaminants (PAH) by flotation in the presence of CAS;
2) stabilization of the inorganic contaminants (fluoride ions) in the presence of (Ca(OH)₂); and
3) recuperation of inorganic contaminants following neutralization of the effluents by adding sulphuric acid.

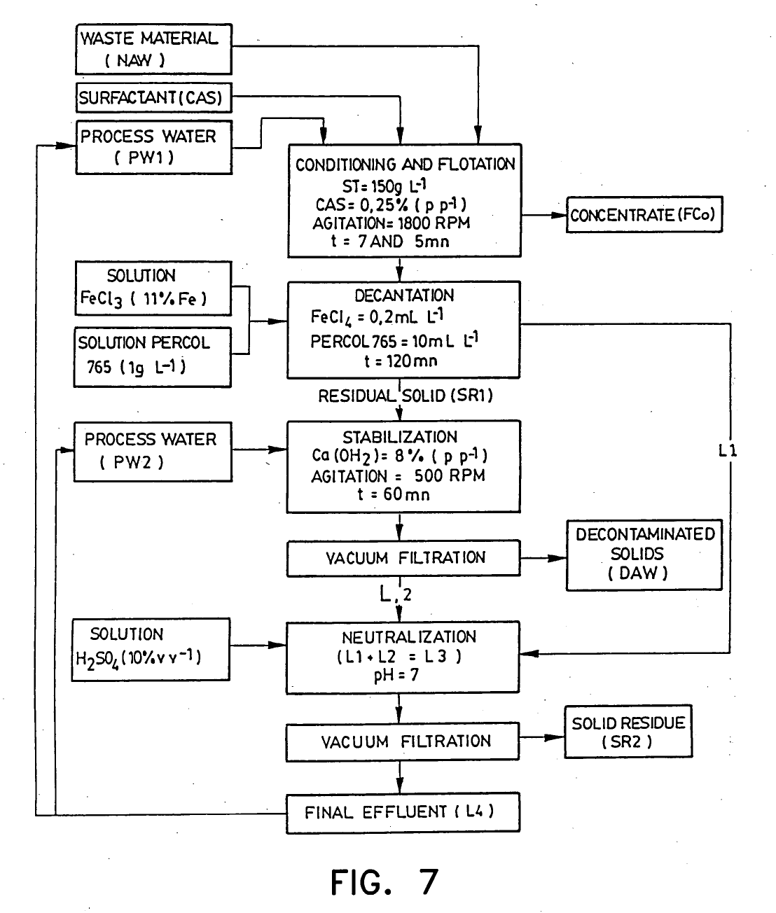

The looped process is presented in FIG. 7.

The process was tested on six consecutive loops (B1 to B6), each loop treating a mass of 150 g of NAW. The optimal parameters for each of the phases of the process were determined during preceding experiments and, consequently, were used in this example.

### Extraction of PAH by Flotation

A mass of 150±1 g of waste was mixed with 1 000 mL of tap water in a Denver type flotation cell (volume 2 L). The homogenization of the pulp (15% in total solids (150 g L⁻¹)) was done by stirring for 10 min at 1 800 rpm. The air flow rate for bubble making was measured at 1 L min⁻¹. After each flotation, the concentrate or froth called FCO was recuperated by overflow and dried for 48 h at 60° C., then weighed. Quantities of 1 to 2 g of FCO were isolated for the extraction step by Söxhlet.

After the second flotation the non floated material was decanted, with ferric chloride and Percol 765. Volumes of 0.2 mL of ferric chloride (11% Fe) and then 10 mL of Percol 765 at 1 g L⁻¹ were added to the reject of flotation SR1 in a 1 000 mL cylinder, agitated for 5 sec. After 120 min of decantation, the supernatant (L1) was taken into a cylinder of 1 000 mL, and conserved. Nevertheless, samples of 20 mL of L1 were removed for fluoride analysis. The solid fraction (SR1) was brought to the next phase of the process.

Table 15 shows the results for this first step of the process for all of the loops.

TABLE 15
PAH content in concentrates of flotation FCO and
removal of PAH from NAW
obtained from loops B1 to B6

| | Concentration (mg kg⁻¹) | | | | | | Removal of PAH (%) | | | | | |
|---|---|---|---|---|---|---|---|---|---|---|---|---|
| HAP | B1 | B2 | B3 | B4 | B5 | B6 | B1 | B2 | B3 | B4 | B5 | B6 |
| Benzo(a)anthracene | 2 609 | 2 485 | 3 068 | 1 587 | 2 211 | 3 081 | 76 | 87 | 71 | 75 | 88 | 64 |
| Benzo(a)pyrene | 458 | 273 | 315 | 215 | 271 | 289 | 92 | 94 | 85 | 89 | 95 | 62 |
| Benzo(b,j,k)fluoranthene | 16 360 | 15 546 | 17 134 | 9 531 | 13 477 | 17 876 | 70 | 81 | 49 | 65 | 83 | 47 |
| Benzo(g,h,i)perylene | 3 237 | 2 837 | 3 116 | 1 475 | 2 235 | 2 914 | 99 | 98 | 97 | 97 | — | 58 |
| Chrysene | 8 493 | 7 691 | 9 738 | 6 003 | 6 864 | — | 59 | 83 | 64 | 64 | 82 | 61 |
| Dibenzo(a,h)anthracene | 1 706 | 1 676 | 2 034 | 837 | 1 291 | 1 702 | — | — | — | — | — | 75 |
| Fluoranthene | 1 778 | 1 412 | 1 550 | 826 | 1 525 | 1 706 | 79 | 86 | 77 | 74 | 86 | 65 |
| Indeno(1,2,3-c,d)pyrene | 2 959 | 2 739 | 3 120 | 1 420 | 2 151 | 2 855 | 99 | 98 | 97 | 98 | — | 56 |
| Pyrene | 2 127 | 1 725 | 1 941 | 1 002 | 1 780 | 2 115 | 77 | 85 | 74 | 74 | 86 | 66 |

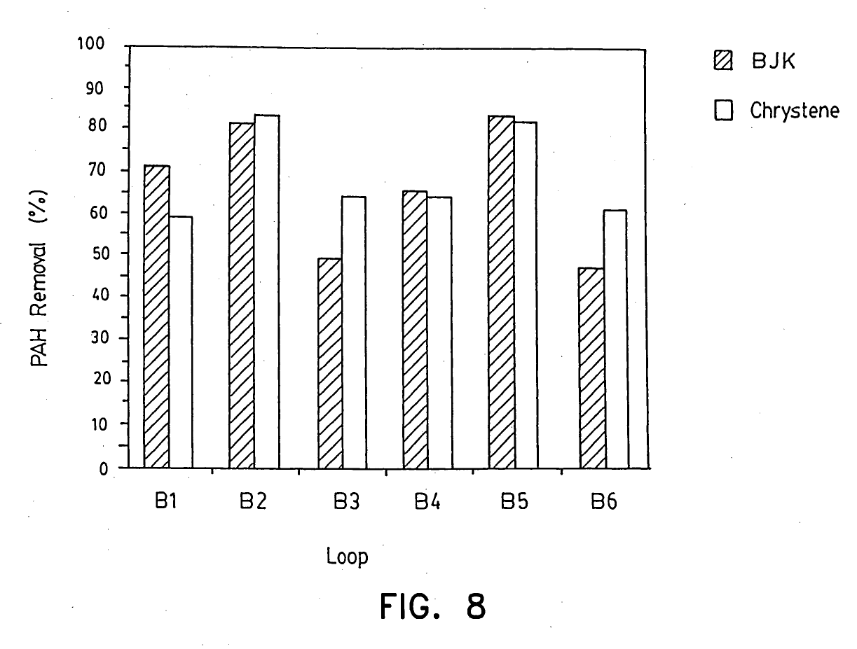

FIG. 8 also shows results regarding the removal of benzo(b,j,k)fluoranthene (BJK) and chrysene in the decontaminated fraction DAW for B1 to B6.

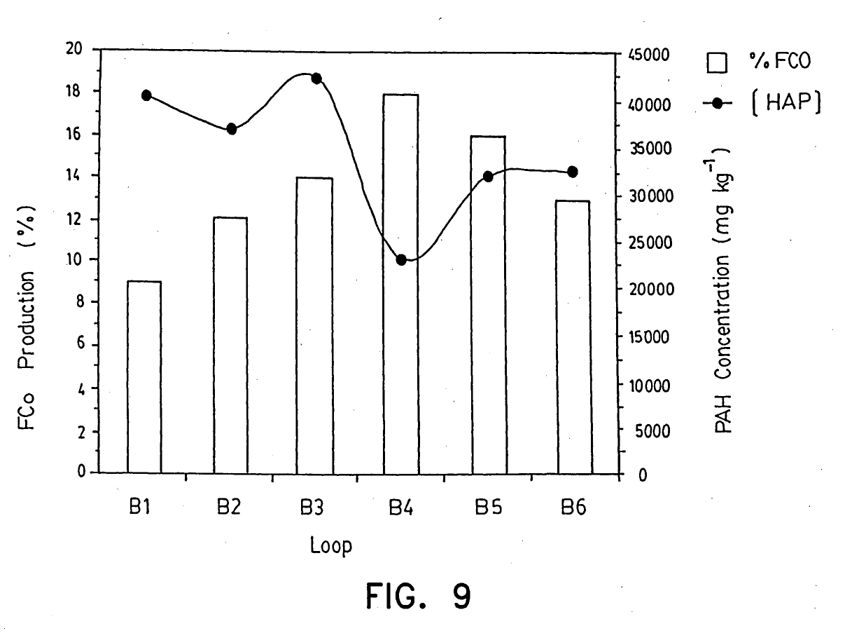

FIG. 9 shows the mass proportions of the FCO and their PAH concentration for each loop.

Table 16 shows the distribution of PAH in the different fractions of the process.

TABLE 16
Distribution (mg) of PAH in the NAW, DAW and FCO fractions, and
yield (%) of recuperation of PAH for loops B1 to B6

| | Loop | | | | | |
|---|---|---|---|---|---|---|
| Fraction | B1 | B2 | B3 | B4 | B5 | B6 |
| NAW (EC05) | 432 | 432 | 432 | 432 | 432 | 432 |
| DAW | 96 | 54 | 116 | 93 | 44 | 170 |
| FCO | 240 | 235 | 318 | 262 | 308 | 210 |
| Yield (%) | 78 | 67 | 100 | 83 | 82 | 89 |

Table 17 shows the distribution of BJK in the different fractions of the process.

TABLE 17
Distribution (mg) of benzo(b,j,k)fluoranthene (BJK) in the
NAW, DAW and FCO fractions, and yield (%) of
recuperation of PAH for loops B1 to B6

| | Loop | | | | | |
|---|---|---|---|---|---|---|
| Fraction | B1 | B2 | B3 | B4 | B5 | B6 |
| NAW (EC05) | 170 | 170 | 170 | 170 | 170 | 170 |
| DAW | 47 | 30 | 71 | 50 | 24 | 81 |
| FCO | 105 | 118 | 157 | 122 | 154 | 148 |
| Yield (%) | 90 | 87 | 134 | 101 | 104 | 134 |

### Stabilization of Fluoride Ions

The rejects SR1 were transferred into a beaker of 2000 mL containing 1000 mL of tap water and 12 g of Ca(OH)2. The quantity of lime corresponds to a concentration of 8% (w w⁻¹) of the mass of the initial waste material on a dry basis (150 g). The mixture was maintained at ambient temperature and agitated (Caframo) for 60 min at 500 rpm. Vacuum filtration was done afterward this step (membrane Whatman no. 411, porosity of 20 μm).

The solid fraction obtained from the filtration is the decontaminated solids (DAW). 50 g of DAW was removed to perform TCLP tests for fluorides. The rest was put in an incubator at 60° C. for 24 h. It was then weighed and then submitted to Söxhlet extraction in order to do the PAH analysis.

The liquid fraction (called L2) was then mixed with L1 to give L3, which was sent to the third part of the process.

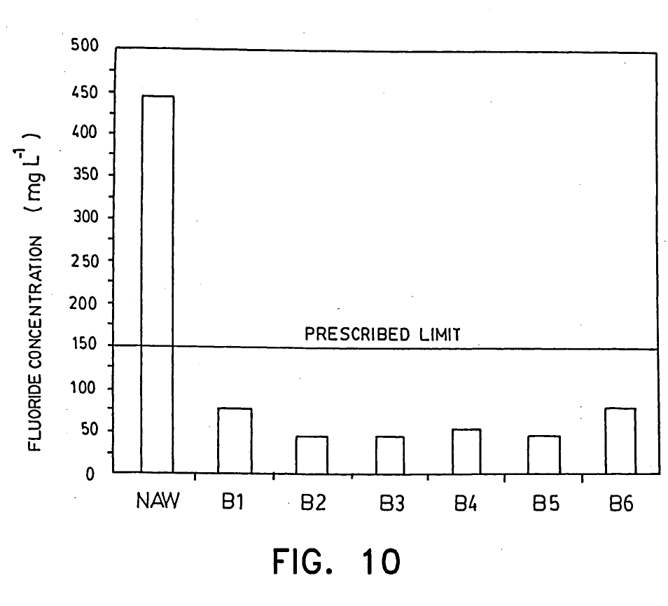

FIG. 10 summarizes the fluoride concentrations in solution for the TCLP test in the NAW and the DAW for loops B1 to B6. A reduction of about 85% in leachable fluoride ions is obtained for TCLP tests.

Table 18 summarizes the fluoride quantities in the different solid and liquid fractions of the process.

TABLE 18
Distribution (mg) of fluorides in the fractions of B1 to B6

| | Loop | | | | | |
|---|---|---|---|---|---|---|
| Fraction | B1 | B2 | B3 | B4 | B5 | B6 |
| NAW | 21 270 | 13 760 | 19 500 | 22 320 | 26 900 | — |
| DAW | 20 330 | 15 560 | — | 19 090 | 25 170 | 24 240 |
| FCO | 1 030 | 1 510 | 1 860 | 1 890 | 1 970 | 1 520 |
| L1 | 225 | 170 | 200 | 140 | 165 | 120 |

These results indicate that the fraction of soluble fluoride compounds in the waste material is relatively low.

### Neutralization of Leachate Solution

The neutralization was done by adjusting the pH of L3 to 7 with sulphuric acid (10% v v⁻¹). The treatment was done in glass agitated reactors. L3 was subjected to vacuum filtration and the solid residue (SR2) was dried at 60° C. for 24 h. L4 is the final effluent.

L4 was recirculated for B2 liquid as illustrated in FIG. 7. The recirculation of L4 was done until the sixth loop B6.

Table 19 summarizes the concentrations (mg L⁻¹) of fluoride ions in the liquid fractions L1, L3 and L4 for B1 to B6.

TABLE 19

Loop

| Fraction | B1 | B2 | B3 | B4 | B5 | B6 |
|---|---|---|---|---|---|---|
| L1 | 320 | 240 | 280 | 200 | 230 | 170 |
| L3 | — | 370 | 160 | 270 | 220 | 470 |
| L4 | — | 317 | 157 | 256 | 168 | 487 |

For SR2 the average concentration of total fluorides was 44 500±3 700 mg kg⁻¹. Neutralization by H₂SO₄ causes a recuperation of fluoride ions. For the total process, the NAW generates about 9.8 g of SR2 (1.08%), which corresponds with a fluoride content of 436 mg for 900 g of NAW.

### Mass and Volume Balance of the Process

Table 20 summarizes the mass and volume balances of the process.

TABLE 20

| | Mass balance | Volume balance |
|---|---|---|
| Parameters | (dry mass, mg) | (volume, mL) |
| Inputs | | |
| Waste material (NAW) | 150 ± 1 | — |
| Surfactant (CAS) | 0.37 | — |
| CaOH₂ | 12 | |
| Process water (PW1) | — | 1 005 ± 5 |
| Process water (PW2) | — | 885 ± 62 |
| Solution FeCl₃ | | 0.20 ± 0.02 |
| Solution polymer (Percol) | | 8 ± 1 |
| Solution H₂SO₄ | | 17 ± 3 |
| Total Inputs | 163 | 1 915 |
| Outputs | | |
| Decontaminated waste (DAW) | 127 ± 13 | 70 |
| Concentrate of flotation (FCO) | 21 ± 5 | 285 |
| Solid residue (SR2) | 1.7 ± 0.6 | — |
| Effluent (L4) | — | 1 335 ± 303 |
| Total Outputs | 150 | 1 690 |
| Ratio Outputs/Inputs | 0.92 | 0.88 |
| Internal components | | |
| Solid reject (SR1) | 130 ± 4.9 | |
| Effluent (L1) | — | 705 ± 108 |
| Effluent (L2) | — | 900 ± 31 |
| Effluent (L3) | — | 1 445 ± 231 |

It should be understood that the embodiments and examples shown and illustrated herein should not be interpreted as limiting of what has actually been invented.

1: A process for treating a waste material coming from aluminum production, the waste material containing contaminants comprising polycyclic aromatic hydrocarbons (PAH) and inorganic fluoride compounds containing fluoride ions, the process comprising in no particular order:
flotation of a waste mixture comprising the waste material in the presence of a surfactant capable of producing PAH-rich micelles that are floated to produce froth comprising the PAH-rich micelles; and
stabilization of the waste mixture by adding a fluoride ion stabilizer to form stabilized fluoride compounds with reduced solubility in the waste mixture and in a toxicity characteristics leaching procedure test, to thereby produce decontaminated solids comprising the stabilized fluoride compounds and a leachate solution.

2: The process of claim 1, comprising:
a. mixing the waste material with a first liquid to produce the waste mixture;
b. adding the surfactant to the waste mixture;
c. generating vapor bubbles in the waste mixture to produce the froth comprising the PAH-rich micelles via flotation, as well as a PAH-poor solution and residual solid waste; and
d. mixing the residual solid waste with a second liquid and the fluoride ion stabilizer to form the stabilized fluoride compounds with reduced solubility in the second liquid and in a toxicity characteristics leaching procedure test, to thereby produce the decontaminated solids comprising the stabilized fluoride compounds and the leachate solution.

3: The process of claim 2, wherein the first and second liquids of steps a) and d) are aqueous.

4: The process of any of claim 2, wherein in step a) the waste material is present in an amount between about 5 and about 20 wt % relative to the total weight of the waste mixture and the surfactant is added in an amount of about 0.2 to about 2% by weight relative to the dry basis weight of the waste material.

5: The process of claim 4, wherein the waste material is present in an amount of about 15 wt % relative to the total weight of the waste mixture.

6: The process of claim 4, wherein the surfactant is added in a percentage of about 0.25% by weight relative to the dry basis weight of the waste material.

7: The process of claim 2, wherein the surfactant is charged.

8: The process of claim 7, wherein the surfactant is a zwitterion.

9: The process of claim 8, wherein the zwitterion has two hydrophilic charged groups and the intermolecular distance between the hydrophilic charged groups is more than about 5 Å.

10: The process of claim 9, wherein the intermolecular distance is between about 6 Å and about 7 Å.

11: The process of claim 2, wherein the surfactant is a sulfobetaine.

12: The process of claim 11, wherein the sulfobetaine is a hydroxysultaine.

13: The process of claim 12, wherein the hydroxysultaine is Cocamidopropyl hydroxysultaine (CAS).

14: The process of claim 2, wherein the surfactant is a non-ionic surfactant.

15: The process of claim 14, wherein the non-ionic surfactant is one of the surfactants defined in formula II or formula III, or a combination thereof: 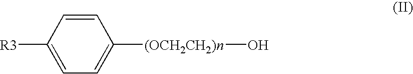
wherein R3 is about C8H17 and n is about 10; and 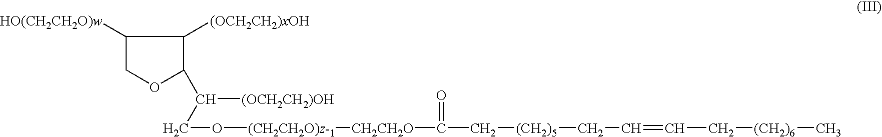
wherein the sum of w+x+y+z is about 20.

16: The process of claim 15, wherein the non-ionic surfactant is Tween 80™ or Triton X-100™ or a combination thereof.

17: The process of claim 2, wherein the vapor bubbles are air bubbles and the generating of the air bubbles comprises agitating the waste mixture.

18: The process of claim 2, wherein the vapor bubbles are air bubbles and the generating of the air bubbles comprises injecting the air bubbles into the waste mixture.

19: The process of claim 2, wherein the fluoride ion stabilizer comprises compounds capable of raising the pH comprising a phosphate and/or an alkali metal, the phosphate and/or the alkali metal forming of the stabilized fluoride compounds.

20: The process of claim 19, wherein the base and soluble compound are added in amounts to raise the pH to between about 9 and about 12.

21: The process of claim 19, wherein the base and soluble compound are added in amounts to raise the pH to about 11.

22: The process of claim 19, wherein the alkali metal is Ca.

23: The process of claim 2, wherein the fluoride ion stabilizer is Ca(OH)₂ and the stabilized fluoride compounds comprise CaF₂.

24: The process of claim 23, wherein the Ca(OH)₂ is added in an amount between about 10 and about 12 g per L of the total volume of the liquid and residual solid waste.

25: The process of claim 2, wherein the fluoride ion stabilizer comprises a phosphate compound and the stabilized fluoride compounds comprise fluoroapatite.

26: The process of claim 2, further comprising:
C1) removing the PAH-rich froth from the PAH-poor solution and the residual solid waste.

27: The process of claim 26, wherein the steps of generating vapor bubbles and removing the PAH-rich froth are performed sequentially multiple times on the waste mixture before performing step d).

28: The process of claim 2, further comprising:
C2) removing the residual solid waste from the PAH-poor solution.

29: The process of claim 2, wherein the removing comprises decanting with the addition of coagulants.

30: The process of claim 29, wherein the coagulants are FeCl₃ or Percol 765 or a combination thereof.

31: The process of claim 2, further comprising separating the decontaminated solids from the leachate solution.

32: The process of claim 2, further comprising after stabilization:
e) neutralizing the PAH-poor solution and/or the leachate solution by adding an inorganic acid to induce precipitation of the fluoride ions remaining in solution, to thereby produce a liquid effluent and a solid residue.

33: The process of claim 32, wherein the inorganic acid is H₂SO₄.

34: The process of claim 32, wherein in step e) the PAH-poor solution and the leachate solution are mixed together and the inorganic acid is added in an amount to bring the pH to between about 7 and about 8.

35: The process of claim 32, further comprising removing the solid residue from the liquid effluent.

36: The process of claim 35, further comprising recycling the liquid effluent for mixing with the waste material of step a) and/or the residual solid waste of step c).

37: The process of claim 36, wherein the second liquid of step d) consists essentially of the liquid effluent emitted from step e).

38: The process of claim 2, further comprising the pre-treatment step of size-reduction of the waste material to have a maximum particle size of about 1 mm.

39: The process of claim 2, wherein prior to step c) the waste mixture undergoes conditioning via agitation.

40: A system for treating waste material coming from aluminum production, the waste material containing contaminants comprising polycyclic aromatic hydrocarbons (PAH) and inorganic fluoride compounds containing fluoride ions, the system comprising:
a flotation vessel for receiving a first liquid and the waste material to produce a waste mixture therein;
a surfactant inlet in fluid communication with the flotation vessel for providing a surfactant into the flotation vessel capable of producing PAH-rich micelles in the waste mixture;
a vapor bubble generator connected to the flotation vessel for generating vapor bubbles in the waste mixture, to produce PAH-rich froth, a PAH-poor solution and residual solid waste;
a stabilization vessel for receiving a second liquid and the waste mixture or the residual solid waste;
a stabilizer inlet in fluid communication with the stabilization vessel for providing a fluoride ion stabilizer therein to mix with the second liquid and the waste mixture or the residual solid waste, to form stabilized fluoride compounds with reduced solubility in the second liquid and in a toxicity characteristics leaching procedure test, to thereby produce decontaminated solids and a leachate solution.

41: The system of claim 40, wherein the stabilization vessel communicates with the flotation vessel to receive the residual solid waste therefrom.

42: The system of claim 40, wherein the vapor bubble generator is an agitator for generating the vapor bubbles of air.

43: The system of claim 40, wherein the flotation vessel is a column having bottom and top sections and the vapor bubble generator is a bubble injector mounted to the bottom section of the column and providing air bubbles thereto.

44: The system of claim 40, wherein the flotation vessel has an open top section and is sized to allow the PAH-rich froth to overflow out of the open top section.

45: The system of claim 40, further comprising a separation device for separating the PAH-poor solution from the residual solid waste.

46: The system of claim 45, wherein the separation device comprises a decanting vessel, coagulant inlets connected to the decanting vessel for providing coagulants therein and outlets for expelling the residual solid waste and the PAH-poor solution.

47: The system of claim 40, further comprising a separator for separating the decontaminated solids from the leachate solution.

48: The system of claim 47, wherein the separator is a vacuum filter.

49: The system of claim 40, further comprising a neutralization vessel for receiving the leachate solution and/or the PAH-poor solution, and comprising an inorganic acid inlet for providing an inorganic acid therein to induce precipitation of the fluoride ions remaining in solution, to thereby produce a liquid effluent and a solid residue.

50: The system of claim 40, further comprising a neutralization separator for separating the liquid effluent from the solid residue.

51: The system of claim 40, further comprising a recirculation assembly comprising a conduit connectable to the neutralization vessel for receiving the liquid effluent and connectable to the flotation vessel and/or the stabilization vessel for providing the liquid effluent thereto, and a pump system connected to the conduit for pumping the liquid effluent between the vessels.

52: The system of claim 40, further comprising a size-reduction apparatus for reducing the particle size of the waste material in the flotation vessel.
